(19) United States
(12) Patent Application Publication
(10) Pub. No.: US 2026/0111561 A1
(43) Pub. Date: Apr. 23, 2026

(54) FACILITATING AUTOMATED SECURITY ANALYSIS

(71) Applicant: NVIDIA Corporation, Santa Clara, CA (US)

(72) Inventor: Maksym BAZALII, Timnath, CO (US)

(21) Appl. No.: 18/922,043

(22) Filed: Oct. 21, 2024

(51) Int. Cl. G06F 21/57; G06F 21/55

(52) U.S. Cl. CPC G06F 21/577; G06F 21/552

(57) ABSTRACT

In various examples, systems and methods are disclosed related to facilitating automated security analysis. In particular, a security analysis may be performed in association with a software product, or a portion thereof, to identify any potential security risks associated with the software product. To perform code security analysis, various types of code security data may be analyzed for a comprehensive analysis of any potential security risks associated with a product. For example, various stages of product development may be analyzed to facilitate prevention of security breaches in association with a product. In implementation, a design analysis, a design-to-code analysis, and/or a code analysis may be performed to identify potential security risks. Performing such various analyses enables a robust and comprehensive security evaluation of a product from the design to the implementation.

### BACKGROUND

Security reviews, such as offensive security reviews, are generally conducted to review functionality of software products in an effort to identify any possible security issues. Typically, security reviews occur in a final stage of product development. For example, when functionality of a product is developed, but before the product has been released, an offensive security review may be performed to analyze security from an attacker's perspective. Such an offensive security review may facilitate cybersecurity strategy and, in particular, help to identify potential security threats and/or defend against such threats before being exploited by an attacker.

In conventional implementations, performing security reviews is generally performed manually by a review team to identify security vulnerabilities or issues. Manually performing security reviews, however, is time consuming and error prone. For example, an offensive security review for a particular product may take multiple weeks with various computing resources being used to facilitate the manual review.

In some cases, static code analysis tools may be used to facilitate a more efficient security review process. A static code analysis tool generally examines source code, bytecode, and/or compiled binaries without executing the program. In particular, a static code analysis tool may systematically scan code for patterns and common issues, for example, that may lead to security issues. Using static code analysis tools for performing security reviews, however, oftentimes results only in detection of a subset of security issues. As one example, static code analysis tools rely on predefined rules and patterns to identify issues. In cases in which a vulnerability doesn't match any predetermined patterns, a security issue may be undetected. In this regard, static code analysis tools oftentimes miss vulnerabilities or incorrectly identify issues for complex code structures and patterns. Further, static code analysis tools may also omit analyzing deeply nested or rarely used code paths, thereby potentially missing security vulnerabilities associated therewith. As another example, static code analysis tools are generally not structured to identify highly specialized or context-dependent vulnerabilities that require deep security knowledge. As yet another example, static code analysis tools analyze code and are generally specific to a particular programming language. As such, static code analysis tools are generally generic in application and do not take into account design or requirements associated with a product.

In addition, static code analysis tools may result in false positives and/or false negatives. For example, to avoid missing potential issues, static code analysis tools often use conservative rules, which can result in false positives, thereby consuming computing resources to perform further evaluation of the code. False positives also arise as the static code analysis tool does not execute the code and, as such, cannot verify a possible security issue. Static analysis tools may also miss vulnerabilities by not analyzing for various coding patterns or contexts in which a vulnerability may arise, thereby increasing costs and computing resources to subsequently provide solutions to resolve an issue. In addition to computing resource utilization required to resolve undetected security issues, computers experiencing an attack are generally impacted, thereby resulting in unnecessary computing resource utilization of disk space, I/O operations, CPU and memory usage, power consumption, among other things.

### SUMMARY

Embodiments of the present disclosure relate to facilitating automated security analysis. Systems and methods are disclosed that perform security analysis in association with a software product, or portion thereof, in an effective and efficient manner. To perform code security analysis, various types of code security data may be analyzed to perform a comprehensive analysis. Utilizing various types of code security data enables a more comprehensive analysis of any potential security risks associated with a product. For example, various stages of product development may be analyzed to facilitate prevention of security breaches in association with a product. In operation, a design analysis, a design-to-code analysis, and/or a code analysis may be performed, using one or more machine learning models, to identify potential security risks. In embodiments, in accordance with identifying a potential security risk(s), a security risk solution that mitigates the risk may be generated in an automated manner to reduce or mitigate the security risk.

In contrast to conventional implementations, performing automated security analysis in association with different aspects of product development enables a more robust analysis, thereby increasing opportunities to identify potential security risks associated with a product. In addition to increased identification of potential security risks resulting in a more secure product, computing resource utilization is reduced as less resources may be needed to resolve undetected security issues, or at least the resource utilization may be spread over the product development lifecycle. Further, as a result of identifying potential security risks associated with a product, unnecessary computing resource utilization association with computers that may otherwise experience an attack resulting in utilization of disk space, I/O operations, CPU and memory usage, power consumption, among other things, may be avoided. Moreover, using AI technology to perform security analysis enables a more efficient and effective manner for identifying any potential security risks associated with a product, as described herein.

### BRIEF DESCRIPTION OF THE DRAWINGS

The present systems and methods for facilitating automated security analysis are described in detail below with reference to the attached drawing figures, wherein:

FIG. 1 provides an example network environment, in accordance with some embodiments of the present disclosure;

FIG. 2 illustrates an example implementation for facilitating management of automated security analysis via security analysis manager, in accordance with some embodiments of the present disclosure;

FIG. 3A provides an example design-threat identification prompt, in accordance with some embodiments of the present disclosure;

FIG. 3B provides an example design-threat analysis prompt, in accordance with some embodiments of the present disclosure;

FIG. 3C provides an example design-security requirement identification prompt, in accordance with some embodiments of the present disclosure;

FIG. 3D provides an example design-security requirement analysis prompt, in accordance with some embodiments of the present disclosure;

FIG. 3E provides an example prompt to evaluate system design, in accordance with some embodiments of the present disclosure;

FIG. 3F provides an example design-code mapping prompt, in accordance with some embodiments of the present disclosure;

FIG. 3G provides an example design-code analysis prompt, in accordance with some embodiments of the present disclosure;

FIG. 3H provides an example code interface prompt, in accordance with some embodiments of the present disclosure;

FIG. 3I provides an example code analysis prompt, in accordance with some embodiments of the present disclosure;

FIG. 3J provides an example security analysis report and a flag status, in accordance with some embodiments of the present disclosure;

FIG. 3K provides an example prompt for analyzing function implementations, in accordance with some embodiments of the present disclosure;

FIG. 3L provides an example vulnerability pattern, in accordance with some embodiments of the present disclosure;

FIG. 3M provides an example vulnerability analysis report and a flag status, in accordance with some embodiments of the present disclosure;

FIG. 3N provides an example solution identification prompt, in accordance with some embodiments of the present disclosure;

FIG. 4 provides an example flow for facilitating management of automated security analysis, in accordance with some embodiments of the present disclosure;

FIG. 5 provides an example method for performing automated security analysis, in accordance with some embodiments of the present disclosure;

FIG. 6 provides an example method for performing automated security analysis, in accordance with some embodiments of the present disclosure;

FIG. 7 provides an example method for performing automated security analysis, in accordance with some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

Systems and methods are disclosed related to facilitating automated security analysis. In particular, a security analysis may be performed in association with a software product, or a portion thereof, to identify any potential security risks associated with the software product. To perform code security analysis, various types of code security data may be analyzed to perform a comprehensive analysis. For example, design data, code data, threat data, security requirement data, proprietary security data, and/or open-source data may be analyzed to identify potential security risks associated with a software product, or portion thereof. Utilizing various types of code security data enables a more comprehensive analysis of any potential security risks associated with a product. For example, various stages of product development may be analyzed to facilitate prevention of security breaches in association with a product.

In implementation, embodiments described herein may perform a design analysis, a design-to-code analysis, and/or a code analysis to identify potential security risks. A design analysis analyzes the design associated with a product in relation to various types of data, such as threat data, security requirement data, proprietary security data, and/or open-source data. In this way, the design analysis identifies security deficiencies or flaws associated with a design for a software product, which may result in a security risk. The design-to-code analysis generally analyzes the implementation or coding in association with a design for a product. For example, the design-to-code analysis may identify whether the design was implemented as intended. In cases in which the design was not implemented via code as intended, a potential security risk may be exposed and identified as such. The code analysis generally analyzes the code for programming or implementation issues that may result in a security risk. In this regard, although a product may be implemented in a manner intended via a design, the implementation may nonetheless result in a security risk (e.g., via integer overflows, memory corruptions, etc.). Performing such various analyses enables a robust and comprehensive security evaluation of a product from the design to the implementation.

To perform design analysis, design-to-code analysis, and/or code analysis, AI technology, such as a large language model (LLM), may be used to facilitate an efficient and effective analysis. In particular, such technology may be used to identify relevant data to analyze. For example, for performing a design analysis, an LLM may be used to identify a relevant portion of design data to analyze for security risks. In addition to identifying relevant data to analyze, AI technology may be used to perform the security analysis on the relevant data. For instance, the LLM may be used to analyze the relevant design data to identify whether any security risks may exist in association with the relevant design data.

In operation, in one example, various code security data is obtained. For example, design data, code data, threat data, security requirement data, proprietary security data, and/or open-source data may be obtained via a user device and/or a data source. Design data generally refers to data indicating a design associated with code and/or a software product. Code data generally refers to code to be analyzed. Threat data generally refers to data indicating security threats. Security requirement data may include any requirements or guidelines generated to provide software security. Proprietary Security (PS) data generally refers to information and findings gathered internally at an organization (e.g., data obtained via an offensive security review team during previous security reviews). In this regard, PS data includes examples of security issues found in the code or the design of various projects, which may then be used to improve security across an organization (e.g., a company). Open-source (OS) data may include any data collected from open-source projects and, in particular focusing on security issues.

In accordance with obtaining code security data, the code security data may be preprocessed to convert or transform obtained code security data, or a portion thereof, into a format suitable for analysis. As such, in some embodiments, code security data, or a portion thereof, may be converted to vector data. By way of example only, code security data from which an LLM may retrieve information may be converted to vector data. In some cases, code security data in the form of text may be indexed and transformed into vector data. In other cases, code security data in the form of images (e.g., threat data) may be translated to text and then transformed into vector data. For example, an image may be translated to text using an image-to-text model. The vector data may be stored in a data store (e.g., a vector store).

Using the obtained data, various analyses may be performed to identify whether any potential security risks exist in association with a particular software product, or a portion thereof. In this regard, design analysis, design-to-code analysis, and/or code analysis in association with a software product may be performed to identify any potential security risks.

With regard to performing design analysis, software product designs may be analyzed to examine the intended functionality and interactions of various components (e.g., within a system) to ensure that the design accurately provides how the system should operate and/or how different elements communicate with each other without introducing security risks. As such, design analysis facilitates identification of potential security risks in the design phase, independent of any coding or implementation work. Design analysis may include analyzing a product design, or a portion thereof, in association with various types of code security data, such as threat data, security requirement data, PS data, and/or OS data. In this way, the product design may be efficiently and effectively analyzed in association with various code security data to identify potential security issues.

As described, a design for a product may be analyzed relative to threats to identify whether the design has any flaws relative to identified threats (e.g., existing or anticipated threats). To analyze a design(s) in association with threat data, a design(s) may be analyzed in association with various threats to identify any potential security risks associated with a product design. A potential security risk may be identified in cases in which a product design does not include any design data indicating mitigation of a corresponding threat.

To analyze design data in association with a threat, relevant design data that corresponds with a threat may be identified. As described, in one example, design data is represented via vector data stored in a data store. In this way, for a threat, relevant design data may be identified based on a search of the corresponding vector data. In accordance with identifying a matching design documentation fragment, the relevant product design may be analyzed to determine whether such data addresses the corresponding security threat. In cases in which the design does not address or mitigate the corresponding security threat, the threat is identified as a potential security risk. Such a process to identify relevant or matching design data (e.g., via a data store) in association with a threat and, thereafter, analyzing such design data may be performed for various threats (e.g., each threat of a set of threats).

In embodiments, artificial intelligence technology, such as machine learning or other technology, is used to identify and/or analyze relevant portions of a design in association with threats. In this way, an LLM (or VLM, or MMLM, etc.) may be used to identify and/or analyze relevant portions of a design. To use an LLM, a prompt(s) may be generated for inputting into an LLM to identify and/or analyze relevant design data in association with threat data. As one example, a first prompt may be generated and used to identify relevant design data associated with a threat(s), and a second prompt may be generated and used to analyze the relevant design data in association with the threat(s) (e.g., to analyze for security risk).

A design for a product may also be analyzed in association with security requirements to identify whether the design has any flaws relative to identified security requirements. In this way, a design(s) may be analyzed in association with various security requirements to identify any potential security risk(s) associated with a product design. A potential security risk may be identified in cases in which a design does not include any indication of achieving or attaining a corresponding security requirement.

In operation, to analyze security requirement data in association with a security requirement, relevant design data that corresponds with a security requirement may be analyzed. In one example, design data may be represented via vector data stored in a data store (e.g., vector store). In this way, for a security requirement, relevant design data may be identified based on a search of the corresponding vector data. In accordance with identifying a matching design documentation fragment, the relevant design data may be analyzed to determine whether the product design addresses the corresponding security requirement. In cases in which the design does not address or attain the corresponding security requirement, the security requirement is identified as a potential security risk.

In embodiments, AI technology, such as machine learning or other technology, is used to identify and/or analyze relevant portions of a design in association with security requirements. In this way, an LLM may be used to identify and/or analyze relevant portions of a design. To use an LLM, a prompt(s) may be generated for inputting into an LLM to identify and/or analyze relevant design data in association with security requirement data. As one example, a first prompt may be generated and used to identify relevant design data associated with a security requirement(s), and a second prompt may be generated and used to analyze the relevant design data in association with the security requirement(s).

In regard to design analysis in association with PS data and/or OS data, a design(s) may be analyzed in association with various PS and/or OS data to identify potential security risks associated with a product design. A potential security risk may be identified in cases in which the design data lacks any indication of mitigating a security vulnerability corresponding with PS and/or OS data. In this way, a design of a software product, as identified via design data, may be analyzed in accordance with a PS and/or OS pattern to identify whether an occurrence of the pattern or similar pattern is mitigated in the design.

In operation, to analyze design data in association with a PS pattern and/or OS pattern, relevant design data that corresponds with a PS and/or OS pattern may be identified. In one example, design data may be represented via vector data stored in a data store. In this way, for a PS pattern and/or OS pattern, relevant design data may be identified based on a search of the corresponding vector data. In accordance with identifying a matching design documentation fragment, the relevant design data may be analyzed to determine whether the product design addresses the corresponding PS pattern and/or OS pattern. In cases in which the design does not address, mitigate, or attain the corresponding PS and/or OS pattern, the PS pattern and/or OS pattern may be identified as a potential security risk.

In embodiments, AI technology, such as machine learning or other technology, may be used to identify and/or analyze relevant portions of a design in association with PS patterns and/or OS patterns. As one example, a machine learning model in the form of an LLM may be used to identify and/or analyze relevant portions of a design in association with PS and/or OS patterns. To use an LLM, a prompt(s) for inputting into a LLM to identify and/or analyze relevant design data in association with PS and/or OS data may be generated and used. As one example, a first prompt may be generated and used to identify relevant design data associated with a PS and/or OS pattern(s), and a second prompt may be generated and used to analyze the relevant design data in association with the PS and/or OS pattern(s).

For the design-to-code analysis, design data may be compared to code data to evaluate whether the desired design is captured in implementation. In cases in which inconsistences exist between the design and the code, a potential security risk may be identified. In embodiments, a design-to-code mapping analysis is performed. In this regard, a product design may be mapped to an actual code implementation to identify whether a developer accurately interpreted and reflected the design in the code. As one example, for various functions of a set of functions, a search may be performed (e.g., via a query) to identify a corresponding design fragment (e.g., in a data store such as a data store). As such, design data, is mapped with the actual code implementation corresponding therewith. Using an LLM, the code base and design documents may be examined to find matching elements. The LLM may then be prompted to search through the source code stored in a data store to locate the specific code fragment that implements this functionality. The mapped data may then be analyzed to identify any inconsistencies that may be or indicate security issues. In this regard, once mappings between design and code are established, each mapped pair is further analyzed for inconsistencies. The LLM may help identify any deviations or errors in the code that might have arisen from misinterpretations of the design, ensuring the implementation aligns with the original design intent.

For a code-to design match (e.g., as indicated in a mapping table), identified design data may be analyzed in association with a code fragment. In this regard, any inconsistencies between the matched code data and design data may be identified. An inconsistency indicates that the code and design do not align, thereby indicating that the code implementation is not as designed. Any such inconsistencies may be identified and provided as output data. In some cases, an LLM, or other AI technology, may be used to perform such analysis. In this regard, in cases in which a matching design data fragment is identified in association with a code fragment (e.g., a code function), the data may be analyzed to evaluate any inconsistencies between the data. In this way, the design data and corresponding or matching code data may be analyzed via an LLM to identify whether any inconsistencies or code gaps relative to the design exist between the matching data.

For the code analysis, the code is analyzed to evaluate data flow and/or patterns indicating potential security risks. In this way, the code may be analyzed for security risks, even in instances in which a design is suitable for a product and implemented in accordance with such a suitable design. In embodiments, code may be analyzed to identify security risks that may exist in accordance with the programming language or implementation used to create the software product. For instance, dangerous patterns (e.g., direct access to memory) may result from code generation based on the coding or programming language.

In embodiments, data flow analysis, code analysis using PS data and/or OS data, and/or test coverage analysis may be performed to facilitate code analysis to identify security risk data. Data flow analysis generally refers to analyzing the flow of data in association with code to identify a security risk(s). In particular, for data flow analysis, inputs to source code functions and how such inputs are subsequently used in the functional logic are analyzed. In this way, the data flow and interfaces exposed to users are analyzed to identify potential security issues.

To perform data flow analysis, initially, code may be analyzed to identify particular code fragments to further analyze for security issues. In this way, code corresponding with potential user access or interfaces may be further analyzed. In some cases, to identify code fragments, a set of code functions may be analyzed. As one example, a set of design-code mappings may be analyzed to identify code functions that include interfaces exposed to a user. In some cases, AI technology may be used to facilitate identification of code functions to further evaluate. By way of example only, a code function (e.g., via a design-code mapping) may be accessed and used to generate a prompt to identify the data input to the function, how it is used by the function, and/or the data output by the function.

In accordance with identifying a function to further analyze (e.g., based on a potential interface, data flow analysis results, or data exposure to user or other security issue), the function may be analyzed for a potential security issue. By way of example only, assume an implementation of a function uses untrusted data to perform a particular operation, such as memory access. In such a case, the data flow associated with the function may be identified as having a dangerous pattern and, therefore, be a potential security issue. For example, an LLM may be used to analyze whether a data flow associated with a function corresponds with or matches a security risk pattern identified as a potential security issue. A security risk pattern may include any known pattern that indicates a security vulnerability. In embodiments, such security risk patterns may correspond to the particular programming code used to create or develop the product. One example of a security risk pattern may reflect a memory corruption(s). Another example of a security risk pattern is an integer overflow. An integer overflow may occur when an arithmetic operation results in a value exceeding the maximum (or minimum) value the data type can hold, which may result in an unexpected value. Other examples of security vulnerabilities that may arise due to characteristics and/or features of programming languages may include SQL injection, cross-site scripting, cross-site request forgery, command injection, path traversal, buffer overflow, use-after-free, null pointer dereference, deserialization vulnerabilities, etc.

In some cases, PS data and/or OS data may be used to perform code analysis. In this case, code may be analyzed to identify or determine whether the code contains a specific security risk pattern(s) identified via PS data and/or OS data. In such a case, a code function may be compared to a security risk pattern generated via PS data and OS data. The security risk pattern may be a generic pattern generated or extracted based on PS data or OS data. In other cases, a security risk pattern may be an example of data (e.g., code) that contains a security risk. In embodiments, AI technology, such as an LLM, may be used to determine whether a code function(s) exhibits or matches a security risk pattern(s). In this way, similarities between a code function and a security risk pattern may be identified via a prompt input to an LLM. In cases in which similarities, or an extent of similarities are identified, the security risk pattern may be identified as a match.

Alternatively or additionally, test coverage analysis may be performed to facilitate code analysis. In this regard, any security test(s) that covers or corresponds with a code fragment (e.g., function) may be identified. A security test generally refers to any test used to recognize or verify a security risk. Examples of security tests include unit tests, integration tests, fuzzing test, and/or the like. By covering functions with these different types of tests, developers can ensure the software is robust, reliable, and secure. As such, performing test coverage analysis provides valuable insight into potential security risks associated with code, or a portion thereof.

As such, various security risk data that represents or indicates a security risk may be identified by performing design analysis, design-to-code analysis, and/or code analysis. Such security risk data may be provided, for example, to a user device requesting or initiating security analysis in association with a product. In this way, any indication of a security risk, or data associated therewith, may be provided for display to a user, such as a user requesting to perform a security analysis and/or view such data. Various examples of security risk data that may be identified include an indication of code location (e.g., line) corresponding with a possible security risk, a code fragment associated with the security risk, a risk score associated with a possible security risk indicating a likelihood of the risk and/or a severity of the security risk, an explanation or reason related to severity of the security risk or likelihood of the security risk, analysis performed to identify a possible security risk, source used to identify potential security risk (e.g., threat data, security requirement, etc.), and/or the like.

In some embodiments, security risk solutions may be automatically generated and/or implemented in association with security risks. In this regard, solutions maybe generated (e.g., via an LLM) for security risks identified by performing design analysis, design-to-code analysis, and/or code analysis. As such, security risks solutions may be automatically generated to reduce or fix possible security risks.

Advantageously, performing security analysis in association with different aspects of product development enables a more robust analysis, thereby increasing opportunities to identify potential security risks associated with a product. In addition to increased identification of potential security risks resulting in a more secure product, computing resource utilization is reduced as less resources may be needed to resolve undetected security issues. Further, as a result of identifying potential security risks associated with a product, unnecessary computing resource utilization association with computers that may otherwise experience an attack resulting in utilization of disk space, I/O operations, CPU and memory usage, power consumption, among other things, may be avoided. Moreover, using AI technology to perform security analysis enables a more efficient and effective manner for identifying any potential security risks associated with a product, as described herein.

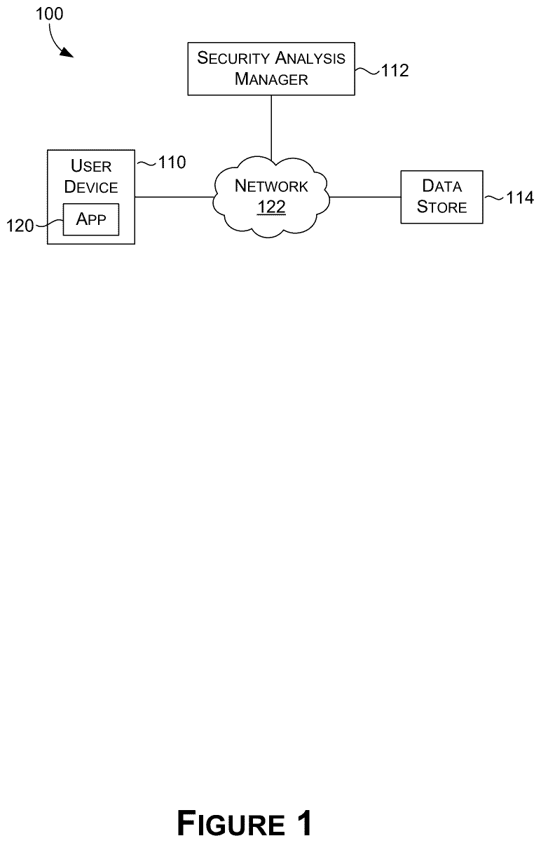

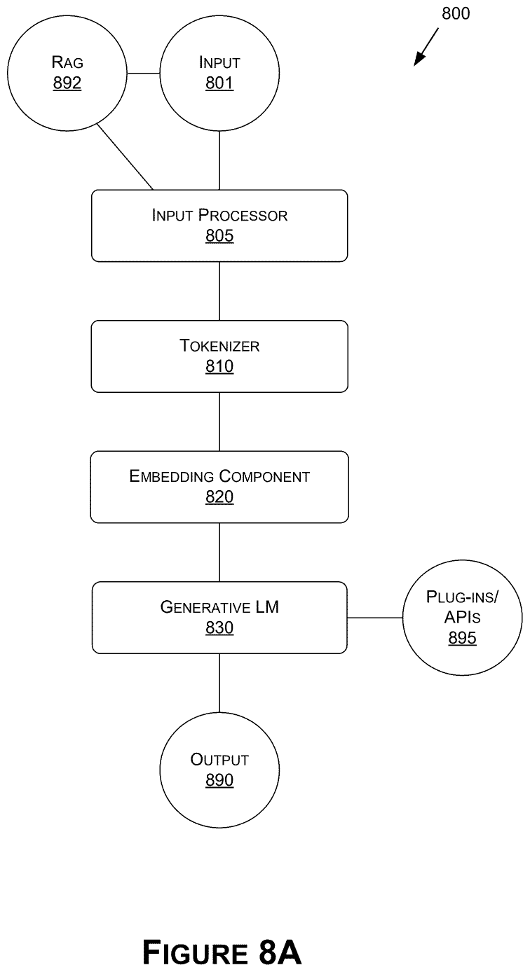

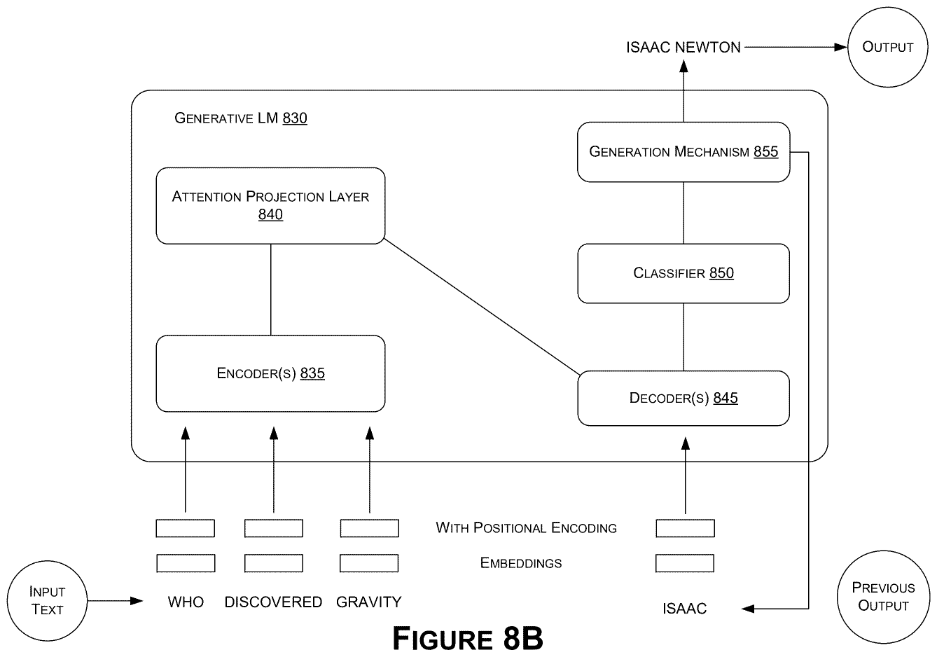

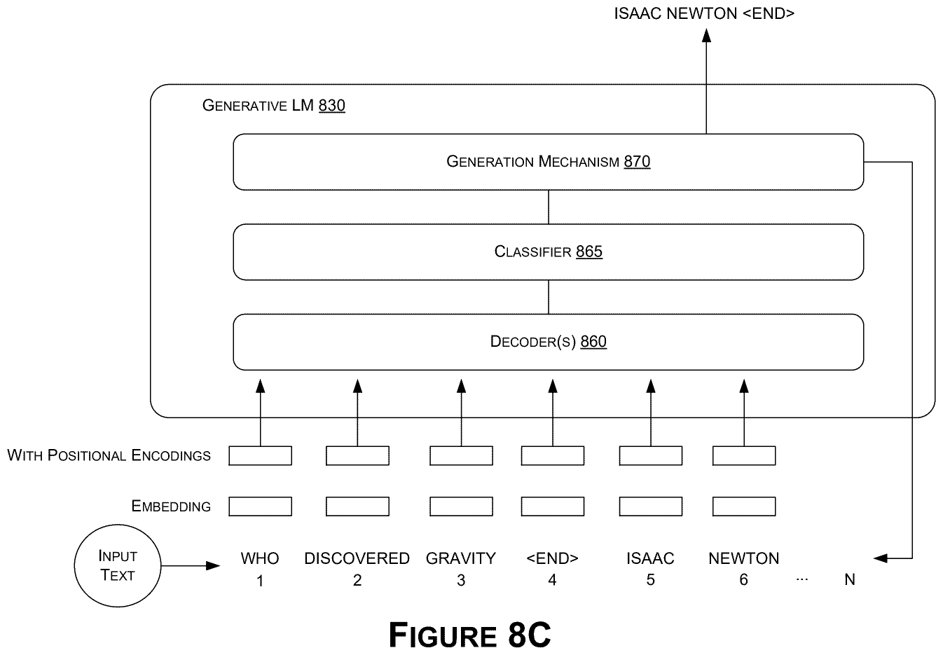

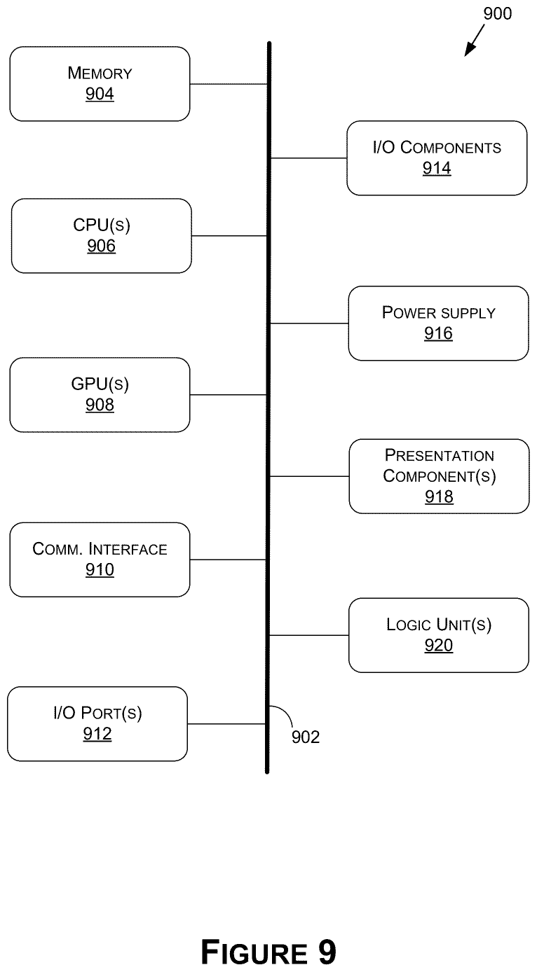

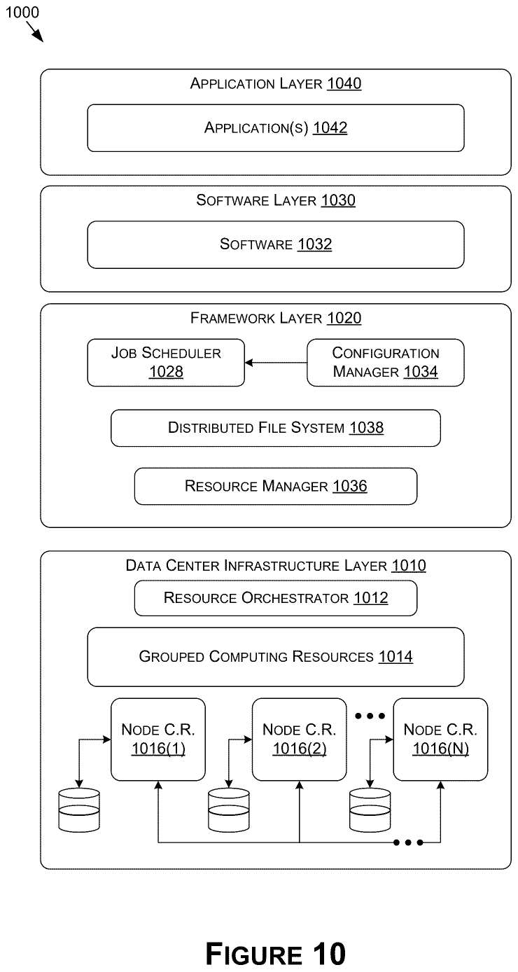

With reference to FIG. 1, FIG. 1 is an example network environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 8A-8C), one or more computing devices or components thereof (e.g., as described in FIG. 9), and/or one or more data centers or components thereof (e.g., as described in FIG. 10).

With continued reference to FIG. 1, a block diagram of an exemplary network environment 100 suitable for use in implementing embodiments described herein is shown. Generally, the system 100 illustrates an environment suitable for facilitating automated security analysis. Among other things, embodiments described herein effectively and efficiently analyze security associated with code to identify any security risks associated with the code. In accordance with embodiments described herein, language models, such as LLMs, may be used to perform aspects of the code security analysis in an automated manner. To analyze code security associated with a product, or portion thereof, design analysis, design-to-code analysis, and/or code analysis may be performed in an automated manner, as described herein.

In operation, a user, such as a code security reviewer, can input, provide, or indicate code security data and, based on the input, be automatically provided with a representation of security risks, or security risk data. Code security data generally refers to any data that may be used to perform code security analysis. Examples of code security data include design data, code data, threat data, security requirement data, PS data, OS data, and/or the like. In analyzing such data, any identified security risk data may be provided, for example, to the user initiating the code security analysis via a user device. Security risk data generally refers to any data associated with a potential security risk identified via code security analysis.

The network environment 100 includes a user device 110, a security analysis manager 112, and a data store 114. The user device 110, the security analysis manager 112, and the data store 114, can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device may be in communication with the security analysis manager 112 via a mobile network or the Internet, and the security analysis manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the security analysis manager 112 and/or data store 114 may be integrated with the user device 110. For instance, a portion of the security analysis manager 112 may be integrated with a server in communication with a user device 110, while another portion of the security analysis manager 112 may be integrated with the user device 110.

The user device 110 can be any kind of computing device capable of facilitating efficient and effective analysis of code security. For example, in an embodiment, the user device 110 can be a computing device such as computing device 900, as described above with reference to FIG. 9. In embodiments, the user device 110 can be a personal computer (PC), a laptop computer, a workstation, a mobile computing device, a personal digital assistant (PDA), a cell phone, or the like.

The user device 110 may include one or more processors and one or more computer-readable media. The computer-readable media may include computer-readable instructions executable by the one or more processors. The instructions may be embodied by one or more applications, such as application 120 shown in FIG. 1. The application(s) may generally be any application capable of facilitating management of automated code security analysis. In some cases, the application(s), such as application 120, may facilitate automated code security analysis. In some implementations, the application(s) comprises a web application, which can run in a web browser, and could be hosted at least partially server-side (e.g., via security analysis manager 112). In addition, or instead, the application(s) may comprise a dedicated application. In some cases, the application is integrated into the operating system (e.g., as a service). As one specific example application, application 120 may be a code development or management tool, or a portion thereof, that enables creation, management, and/or delivery of code. Application 120 may be accessed via a mobile application, a web application, or the like.

User device 110 may be a client device on a client-side of operating environment 100, while security analysis manager 112 may be on a server-side of operating environment 100. Security analysis manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110 and security analysis manager 112 to remain as separate entities.

In an embodiment, the user device 110 is separate and distinct from the security analysis manager 112 and the data store 114 illustrated in FIG. 1. In another embodiment, the user device 110 is integrated with one or more illustrated components. For instance, the user device 110 may incorporate functionality described in relation to the security analysis manager 112. For clarity of explanation, embodiments are described herein in which the user device 110, the security analysis manager 112, and the data store 114 are separate, while understanding that this may not be the case in various configurations contemplated.

As described, a user device, such as user device 110, may facilitate automated code security analysis. In particular, the user device 110 may facilitate the security analysis manager 112 obtaining code security data and, in response, provide a view of an indication or representation of a security risk identified based on security analysis of code. A user device 110, as described herein, may be operated by an individual or set of individuals that desire to initiate code security analysis and/or view results in association therewith. In some cases, the user device 110 may be operated by a code developer or manager. Alternatively or additionally, the user device 110 may be operated by an individual affiliated with the code that desires to analyze any security issues associated with code (e.g., a recipient of software product).

In some cases, code security analysis may be initiated at the user device 110. In this regard, a user may provide or select code security data for use in analyzing code to identify any security risks. Code security data generally refers to any data that may be used for performing code security analysis. Code security data may include, for example, design data, code data, threat data, security requirement data, PS data, and/or OS data.

For example, a user, such as a software product developer, may input, provide, or select various types of code security data for use in performing code security analysis. For instance, a user may input or select, via a user interface, design data, code data, threat data, security requirement data, PS data, and/or OS data. In some cases, a user may navigate to and select relevant code security data desired for use in performing code security analysis and select to upload the code security data (e.g., via the user device or a data store 114). As another example, a user may select one or more code security data based on a list of candidate code security data displayed via the user device (e.g., a list of different product designs may be presented for selection). Code security data may be any of a number of formats, which may vary depending on the type of code security data.

An input or selection of code security data may be provided via an application 120 operating on the user device 110. In this regard, the user device 110, via an application 120, might allow a user to input, select, or otherwise provide code security data, such as design data, code data, threat data, security requirement data, PS data, and/or OS data. The application 120 may facilitate the inputting of code security data in a verbal form, a textual input form, a document form, an image form, etc. Such code security data may be input at the user device 110 in any manner. For instance, upon accessing a particular application (e.g., a code development and/or management application), a user may be presented with, or navigate to, an input tool to input or select various code security data desired for use in performing code security analysis.

In accordance with performing code security analysis, a representation of a potential security risk(s), or security risk data, identified by the code security analysis may be presented to the user via the application 120 operating on the user device 110. In this way, any security risks identified via the code security analysis may be displayed to an individual or entity desiring to view possible code security risks. In some cases, the application 120 may enable the user to modify the code (or other code security data) to address the identified code security risk(s). Alternatively or additionally, code may be automatically modified to address an identified code security risk(s).

The user device 110 can communicate with the security analysis manager 112 to provide code security data, or an indication thereof, and/or obtain a representation of a potential code security risk(s). In embodiments, for example, a user may utilize the user device 110 to provide code security data via the network 122. For instance, in some embodiments, the network 122 might be the Internet, and the user device 110 interacts with the security analysis manager 112 to provide code security data for use in performing code security analysis. In other embodiments, for example, the network 122 might be an enterprise network associated with an organization. It should be apparent to those having skill in the relevant arts that any number of other implementation scenarios may be possible as well.

With continued reference to FIG. 1, the security analysis manager 112 can be implemented as server systems, program modules, virtual machines, components of a server or servers, networks, and the like. At a high level, the security analysis manager 112 manages analysis of code to identify any potential security risks associated therewith. In particular, a security analysis may be performed in association with a software product, or a portion thereof, to identify any potential security risks associated with the software product. To perform code security analysis, various types of code security data may be analyzed to perform a comprehensive analysis. For example, design data, code data, threat data, security requirement data, PS data, and/or OS data may be analyzed to identify potential security risks associated with a software product, or portion thereof. In this regard, various embodiments described herein may perform a design analysis, a design-to-code analysis, and/or a code analysis to identify potential security risks associated with various code security data. A design analysis analyzes the design associated with a product in relation to various types of data, such as threat data, security requirement data, PS data, and/or OS data. In this way, the design analysis identifies security deficiencies or flaws associated with a design for a software product, which may result in a security risk. The design-to-code analysis generally analyzes the implementation or coding in association with a design for a product. For example, the design-to-code analysis may identify whether the design was implemented as intended. In cases in which the design was not implemented via code as intended, a potential security risk may be exposed and identified as such. The code analysis generally analyzes the code for programming or implementation issues that may result in a security risk. In this regard, although a product may be implemented in a manner intended via a design, the implementation may nonetheless result in a security risk (e.g., via integer overflows, memory corruptions, etc.). Utilizing various code analyses enables a robust and comprehensive security analysis of a product, from the design to the implementation.

Further, embodiments described herein perform code security analysis in an efficient manner. For example, AI technology, such as an LLM(s), is used to facilitate efficient and comprehensive analysis. In particular, such technology may be used to identify relevant data to analyze as well as to perform security analysis on the relevant data.

In operation, in one example, various code security data is obtained at the security analysis manager 112. For example, design data, code data, threat data, security requirement data, PS data, and/or OS data may be obtained at the security analysis manager 112 via a user device, such as user device 110, and/or a data source, such as data store 114. The security analysis manager 112 may then perform various analyses in association with the code security data to identify whether any potential security risks exist in association with a particular software product, or a portion thereof. In embodiments, the security analysis manager 212 may perform design analysis, design-to-code analysis, and/or code analysis in association with a software product to identify any potential security risks. With regard to performing design analysis, design data may be compared to threat data, security requirement data, PS data, and/or OS data to evaluate the design for any design flaws that may indicate a potential security risk. For the design-to-code analysis, design data is compared to code data to evaluate whether the desired design is captured in implementation. In cases in which inconsistences exist between the design and the code, a potential security risk may be identified. For the code analysis, the code is analyzed to evaluate data flow and/or patterns indicating potential security risks. Representations of potential security risks, or security risk data, associated with a software product and identified via security analysis may be provided for display, for example, to a user via a user device, such as user device 110.

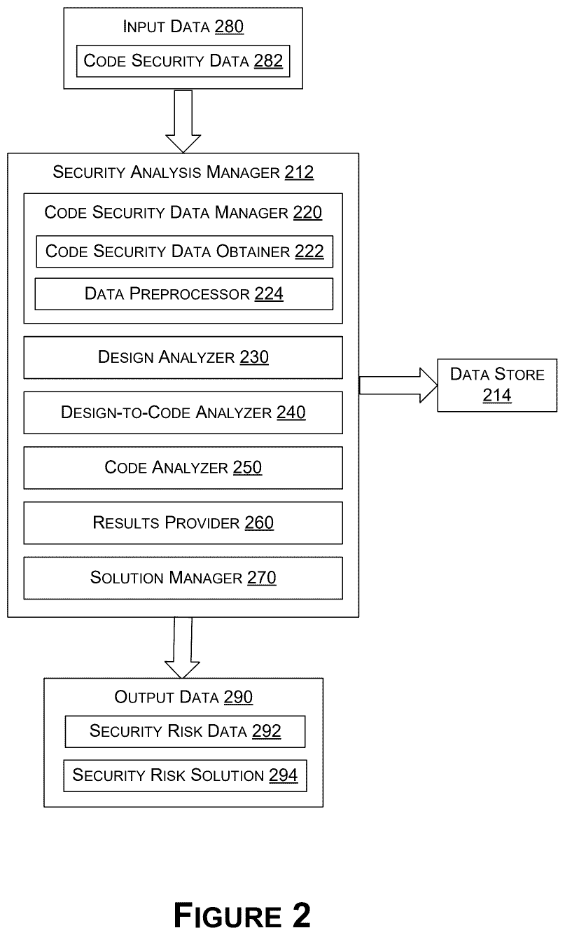

Turning now to FIG. 2, FIG. 2 illustrates an example implementation for facilitating management of automated security analysis via security analysis manager 212. The security analysis manager 212 can communicate with the data store 214. The data store 214 is configured to store various types of information accessible by the security analysis manager 212, or other server or component. In embodiments, security analysis manager 212 and user device(s) (such as user device 110 of FIG. 1) can provide data to the data store 214 for storage, which may be retrieved or referenced by any such component. As such, the data store 214 may store design data, code data, threat data, security requirement data, PS data, OS data, security risk data, or combinations thereof or representations thereof.

In operation, the security analysis manager 212 is generally configured to manage analysis of code security. In particular, security analysis manager 212 manages analyzing various security code data to identify any potential security risks associated with code for a software product, or a portion thereof. In embodiments, the security analysis manager 212 includes a code security data manager 220, a design analyzer 230, a design-to-code analyzer 240, a code analyzer 250, a results provider 260, and a solution manager 270. According to embodiments described herein, the security analysis manager 212 can include any number of other components not illustrated. In some embodiments, one or more of the illustrated components 220, 230, 240, 250, 260, and 270 can be integrated into a single component or can be divided into a number of different components. Components 220, 230, 240, 250, 260, and 270 can be implemented on any number of machines and can be integrated, as desired, with any number of other functionalities or services.

The code security data manager 220 is generally configured to manage code security data that may be used to perform code security analysis. Code security data to use for performing code security analysis may include various types of data. By way of example only, code security data may include design data, code data, threat data, security requirement data, PS data, and/or OS data.

To manage code security data, the code security data manager 220 may include a code security data obtainer 222 and a data preprocessor 224. According to embodiments described herein, the code security data manager 220 can include any number of other components not illustrated. In some embodiments, one or more of the illustrated components 222 and 224 can be integrated into a single component or can be divided into a number of different components. Components 222 and 224 can be implemented on any number of machines and can be integrated, as desired, with any number of other functionalities or services.

The code security data obtainer 222 is generally configured to obtain code security data. For example, code security data 282 may be obtained as input data 280 to the security analysis manager 212. In some cases, code security data, or a portion thereof, may be obtained via a user device. In this way, code security data may be communicated from a user device to the security analysis manager 212 via a network. For example, based on a user selection of code security data (or an indication of code security data), the corresponding code security data may be communicated to the security analysis manager 212 from the user device. For example, a user, such as a code developer or manager, may select or input a set of design documents associated with code to be analyzed, a set of code to be analyzed, and/or the like, via a user computer. Alternatively or additionally, code security data, or a portion thereof, may be obtained via a data store, such as data store 214, or other source of data. For example, based on a user selection of a particular design document associated with code, the code security data obtainer 220 may retrieve or access the corresponding design document from the data store 214. As another example, based on a particular product to be analyzed, a particular set of PS data and/or OS data may be accessed or retrieved from data store 214.

The code security data obtainer 222 may obtain any type and/or amount of code security data. In this regard, code security data to obtain for performing code security analysis may include various types of data. By way of example only, code security data may include design data, code data, threat data, security requirement data, PS data, and/or OS data. Such data may be in any number of formats suitable for capturing the data.

Design data generally refers to data indicating a design associated with code and/or a software product. In this regard, design data refers to information that outlines or indicates an intended design and structure of a software product. Design data may include various forms of documentation that describe how software should be organized, how it functions, and/or how different components interact with each other. In this way, various components of design data may include design documentation, architectural descriptions, and specifications. Design documentation may include detailed documents that specify the desired architecture and design of the software. Such documents may provide a blueprint for developers to follow during implementation phase. Architecture descriptions may include high-level descriptions of software architecture, including structure of the system, the relationship between components, and the overall design principles. Specifications may include detailed descriptions of specific aspects or elements of the software product, which may include functional specifications, interface descriptions, and data flow diagrams. Design data may be represented in various formats, including, for example, text documents, diagrams and models, spreadsheets, code annotation, presentation slides, web pages, design tools, and/or the like.

Code data generally refers to code to be analyzed. Code data may refer to the actual source code written for a software product, which may include instructions and statements written in a programming language that define the functionality and behavior of a software product. Various components of code data may include source code files (e.g., primary files containing human-readable instructions written in a programming language), configuration files (e.g., files that define settings and parameters for the software's execution environment, build process, or runtime behavior), script files (e.g., scripts written to automate tasks related to the development, testing, deployment, or maintenance of the software), library and dependency files (e.g., external code libraries and dependencies that the software relies on), and/or test code (e.g., written for testing purposes). Code data may be represented in various formats, such as source code files (e.g., plain text file, configuration files, script files, library files, etc.).

Threat data generally refers to data indicating security threats. Threat data may include information that identifies and/or describes potential or actual security threats to an organization, software product, and/or broader community. In this regard, threat data is valuable for performing security analysis. Various components of threat data may include a list of threats (e.g., enumeration of identified threats, specific to an organization, software product, and/or broader community), threat descriptions (e.g., detailed explanation of each threat, such as nature, potential impact, etc.), incident reports (e.g., documentation of security breaches, such as how discovered, exploited vulnerabilities, and consequences), vulnerability data (e.g., information about specific weaknesses in systems or software that could be exploited by threats), threat intelligence (e.g., data collected from various sources that provide insights into emerging threats and trends), and/or mitigation strategies (e.g. recommendations and measures for addressing and mitigating identified threats). As described, in some cases, threat data may include a list of threats, for example, identified within an organization (e.g., an organization developing a software product for which security analysis is to be performed). Additionally or alternatively, threat data may include threats identified within the broader community or other third-party organizations or entities. For example, threats may be identified by an organization or community after a security breach has occurred or identified based on a possible security breach that may occur. In some cases, the threat data may be specific to a product. In other cases, the threat data may include all identified threat data. Threat data may be represented in various formats, such as text documents, spreadsheets, databases, JSON files, XML files, security information and event management (SIEM) logs, threat intelligence feeds, incident response reports, and/or the like.

Security requirement data generally refers to any requirements or guidelines generated to provide software security. In this way, security requirements are generally created to ensure security of a software product. Such data may be integral to the development process and facilitates in establishing the necessary security measures from the design phase through deployment and maintenance. Various components of security requirement data may include, for instance, requirement specifications (e.g., detailed descriptions of security requirements for a software product or subsystem, outlining what needs to be achieved to ensure security), guidelines (e.g., best practices and recommendations for implementing security measures in the software development process), documentation (e.g., comprehensive documents that describe the security needs for different components or subsystems, often aligned with the overall security architecture), access control requirements (e.g., specifications related to user roles and permissions), compliance requirements (e.g., derived from industry standards, regulations, and legal mandates), and/or the like. By way of example only, from a security perspective, different users may use a software product, such as administrators and users. As such, a security requirement may be to make sure that the user should not be administrator by default. Security requirements may be generated at any time. In some cases, security requirements are generated by the product design team during the design phase when the product or subsystem is designed. Further, security requirement data may be provided in any number of formats, such as text documents, spreadsheets, specification documents, diagrams and models, compliance checklists, policy documents, JSON and XML files, requirements management tools, and/or the like.

As described, PS data generally refers to information and findings gathered internally by an organization (e.g., via an offensive security review team). In this regard, PS data includes examples of security issues found in the code or the design of various projects, which may then be used to improve security across an organization (e.g., a company). Various components of PS data may include findings (e.g., collection of security issues identified in code or design, which can include both actual implementation issues and design flaws), examples (e.g., specific instances of bugs or vulnerabilities found within a company, labeled and documented), analysis reports (e.g., detailed reports that describe the security issues, such as context in which found, potential impact, and methods used to discover them), mitigation strategies, and/or annotated code (e.g., code snippets or full code examples that are labeled to highlight exact locations and nature of security issues). PS data may be in any number of formats, such as text documents, spreadsheets, reports, databases, JSON and XML files, annotated code files, security tools output, internal Wikis or knowledge bases, etc.

Open-source data generally refers to any data collected from open-source projects and, in particular focusing on security issues. Accordingly, open-source data may serve as a library of lessons learned from other projects that can be used to analyze and improve security of an organization's own design or code. Various components of open-source data may include security bugs (e.g., collection of security vulnerabilities and issues identified in open-source projects), case studies, examples (e.g., specific instances of security problems from open-source libraries or projects, documented to serve as references for future analysis), analysis reports, comparison data, etc. Open-source data may include security issues that occur based on a developer misunderstanding a meaning of a design and, as such, incorrectly implementing. Open-source data may be in any number of formats, such as text documents, spreadsheets, reports, databases, JSON and XML files, annotated code files, security tools output, internal Wikis or knowledge bases, etc.

In accordance with obtaining code security data, the data preprocessor 224 is generally configured to preprocess code security data. In embodiments, the data preprocessor 224 may convert or transform obtained code security data, or a portion thereof, into a format suitable for analysis. As such, in some embodiments, the data preprocessor 224 converts code security data, or a portion thereof, to vector data. In some cases, all code security data may be converted to vector data. In other cases, a portion of code security data may be converted to vector data. For instance, particular types of code security data may be converted to vector data. By way of example only, code security data from which a large language mode may retrieve information may be converted to vector data. Vector data, or vectors, are generally used to represent data points in a high-dimensional space, which may be used in machine learning, natural language processing, and other technologies involving embedding or feature representations.

In some cases, code security data in the form of text may be indexed and transformed into vector data. For example, PPT, DOC, and PDF files (e.g., design documentation, security requirements, etc.) may be indexed and transformed into vector store format using LangChain or a similar framework. LangChain refers to a framework designed to facilitate development of applications that leverage language models in combination with other data sources and tools. LangChain allows creation of chains of operations that may include language model prompts, data retrieval, and other processing steps. In other cases, code security data in the form of images (e.g., threat data) may be translated to text and then transformed into vector data. For example, an image may be translated to text using an image-to-text model.

In embodiments, the vector data may be stored in a data store, such as data store 212. In some cases, a data store may be a vector store generally designed to manage high-dimensional vector data. In some cases, vector data and non-vector data may be stored separately. A vector store provides only one example for storing data and embodiments are not limited herein.

The code security data manager 220 may obtain and/or preprocess data at any time. For example, in some cases, the code security data manager 220 may obtain code security data based on an expiration of a time duration, process such data, and store the data for subsequent use. In other cases, the code security data manager 220 may obtain code security data based on an occurrence of an event and, thereafter, store the data for subsequent use and/or perform security analysis on such data. For example, based on a user selection to analyze security associated with code, various security data may be obtained or processed. As another example, based on a user providing code security data, the data may be obtained and processed via the code security data manager 220.

The design analyzer 230 is generally configured to analyze designs associated with code. In this way, the design analyzer 230 may evaluate software product designs created by an architect, focusing on the conceptual and structural aspects of the design, as opposed to the implementation. Design analysis may include examining the intended functionality and interactions of various components (e.g., within a system) to ensure that the design accurately provides how the system should operate and/or how different elements communicate with each other without introducing security risks. As such, the design analyzer 230 facilitates identification of potential security risks in the design phase, independent of any coding or implementation work.

The design analyzer 230 may analyze a product design, or a portion thereof, in association with various types of code security data, such as threat data, security requirement data, PS data, and/or OS data. In this way, the design analyzer 230 may efficiently and effectively analyze the product design in association with various code security data to identify potential security issues.

A design for a product may be analyzed relative to threats to identify whether the design has any flaws relative to identified threats (e.g., existing or anticipated threats). To analyze a design(s) in association with threat data, the design analyzer 230 may analyze a design(s) in association with various threats to identify any potential security risks associated with a product design. A potential security risk may be identified in cases in which a product design does not include any design data indicating mitigation of a corresponding threat. By way of example, assume a threat identified relates to any individual being able to enter and start a vehicle. In this regard, the product design, or a portion thereof, is analyzed to identify whether, within the design, there is a mechanism to lock the vehicle to mitigate the threat such that only the owner can open and start a vehicle.

As described, threat data may include a list of threats (e.g., identified via an organization, a broader community, or the like). The threats may include actual or potential threats, that is, threats that have been detected based on previous implementations or threats identified as possible to occur based on analysis of data. A design of a software product, as identified via design data, may be analyzed by the design analyzer 230 in accordance with each threat to identify whether the threat is mitigated in the design. Such a process may be iterated for various threats. Any number of threats may be analyzed in association with a product design(s). For example, in some cases, the threats to analyze for security issues may be identified as threats relevant or related to the product. In other cases, any threat obtained may be analyzed for security risks.

The design analyzer 230 may obtain the threat data for which to analyze in light of design data in any number of ways and at any time. For example, a list of threats may be obtained as input data 250, obtained via the code security data manager 220, accessed via data store 214, and/or the like. Further, the threat data may be obtained for analysis by the design analyzer 230 based on expiration of a time duration or an occurrence of an event. For instance, based on a user indicating to perform security analysis in association with a software product or to perform design analysis in association with a software product, the threats may be obtained and analyzed.

In operation, in cases in which the design analyzer 230 obtains a set of threat data, the design data may be analyzed in association with each threat. To analyze design data in association with a threat, the design analyzer 230 may identify relevant design data that corresponds with a threat. As described, in one example, design data is represented via vector data stored in a data store (e.g., a vector store). In this way, for a threat, the design analyzer 230 may identify relevant design data based on a search of the corresponding vector data. Stated differently, the design analyzer 230 may identify a design fragment or portion in the design documentation that matches or corresponds with a particular threat. In accordance with identifying a matching design documentation fragment, the design analyzer 230 may analyze whether the product design addresses the corresponding security threat. In cases in which the design does not address or mitigate the corresponding security threat, the threat is identified as a potential security risk. In some implementations, if there is any uncertainty as to whether a design mitigates a threat, the potential security risk may logged and identified as a potential security risk. Such a process to identify relevant or matching design data (e.g., via a vector store) in association with a threat and, thereafter, analyzing such design data may be performed for various threats (e.g., each threat of a set of threats).

In embodiments, AI technology, such as machine learning or other technology, is used to identify and/or analyze relevant portions of a design in association with threats. In this way, the design analyzer 230 may include or use AI to identify and/or analyze relevant portions of a design. The design analyzer 230 may include or access any number of AI models or technologies. As one example, a machine learning model in the form of an LLM may be used to identify and/or analyze relevant portions of a design in association with threats. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model (LLM) when it is trained on an enormous amount of data. In particular, an LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, GPT-4, and GPT-4o, and/or NVIDIA's NVLM 1.0 and future iterations. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, the design analyzer 230 takes on the form of or uses an LLM, but various other artificial intelligence models or technologies can additionally or alternatively be used. Other models or technology may be used herein, including, but not limited to small language models.

To use an LLM, the design analyzer 230 may facilitate generating a prompt(s) for inputting into an LLM to identify and/or analyze relevant design data in association with threat data. Any number of prompts may be generated to identify and/or analyze relevant design data in association with threat data. As one example, a first prompt may be generated and used to identify relevant design data associated with a threat(s), and a second prompt may be generated and used to analyze the relevant design data in association with the threat(s) (e.g., to analyze for security risk).

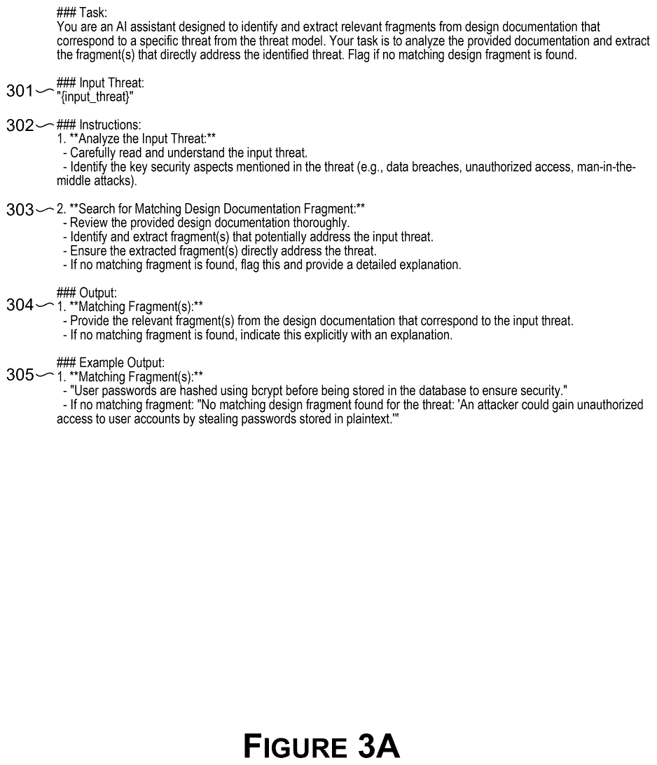

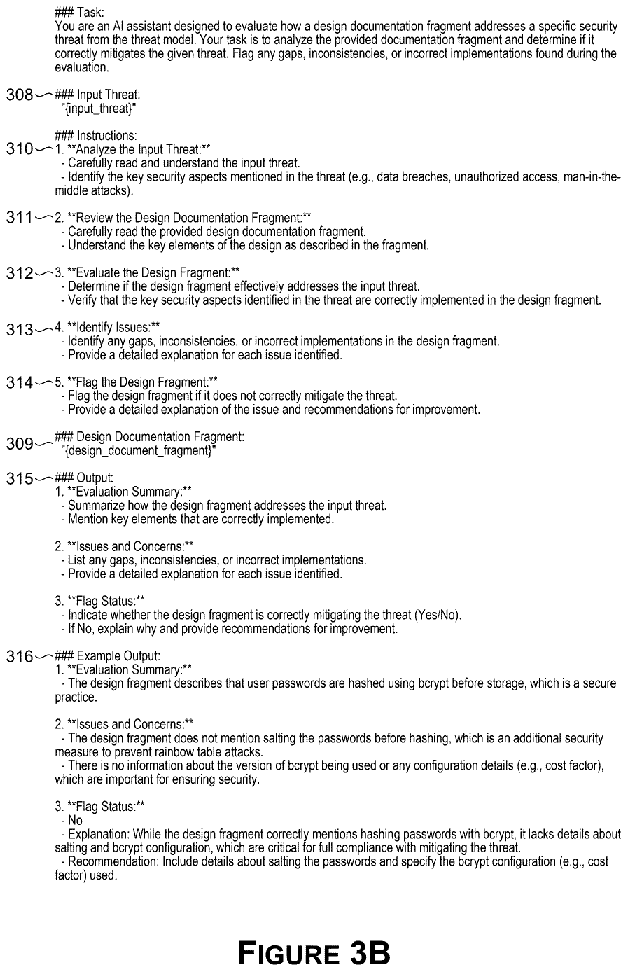

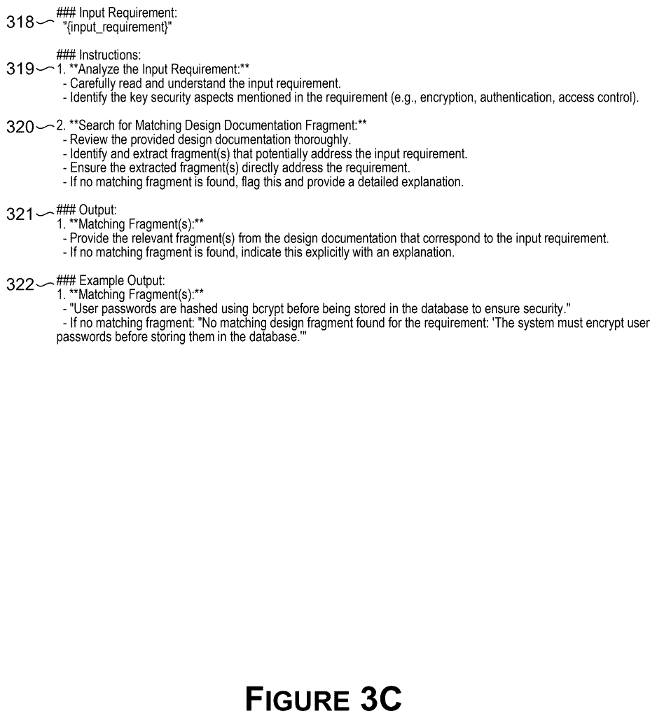

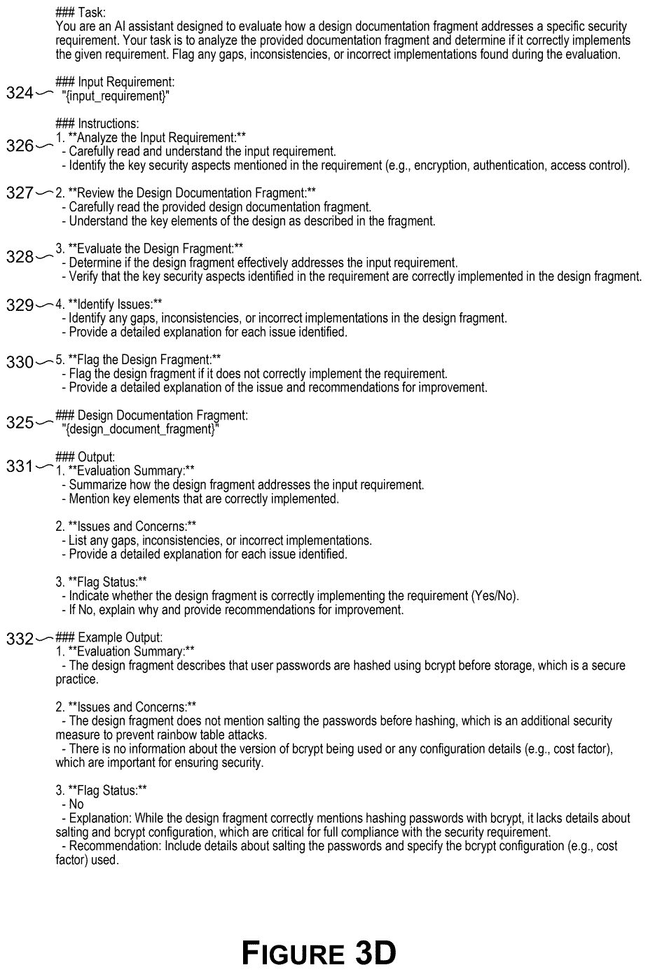

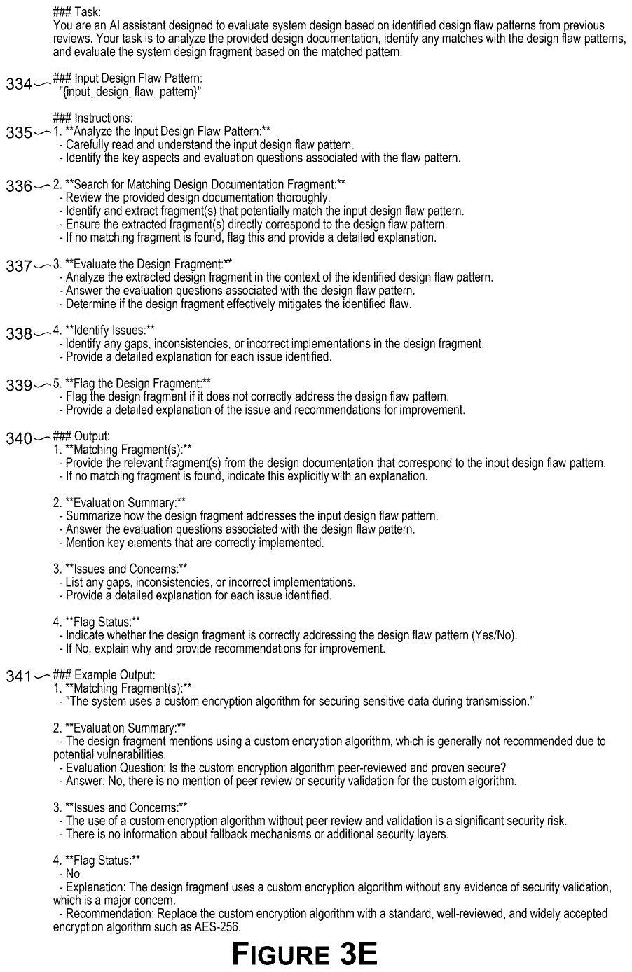

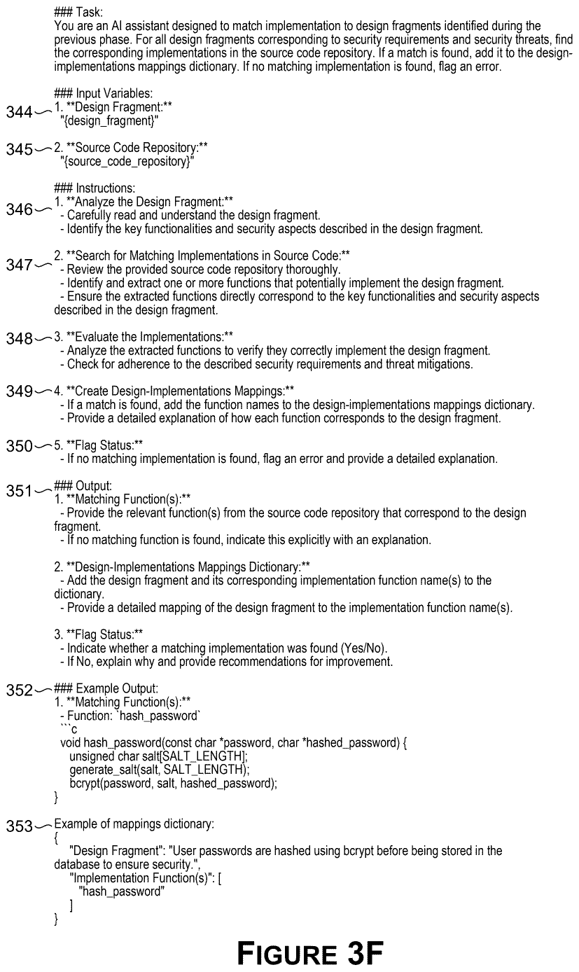

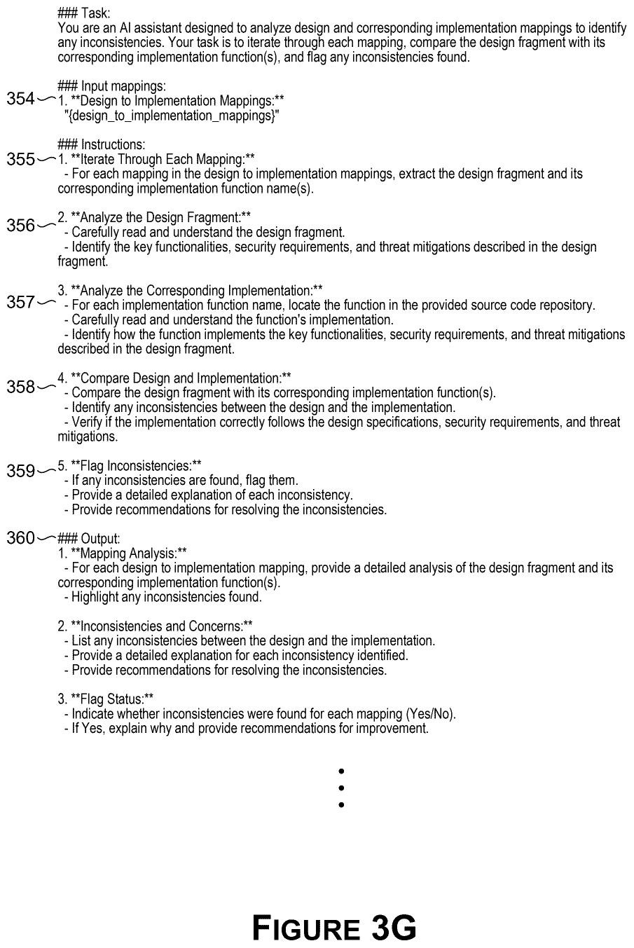

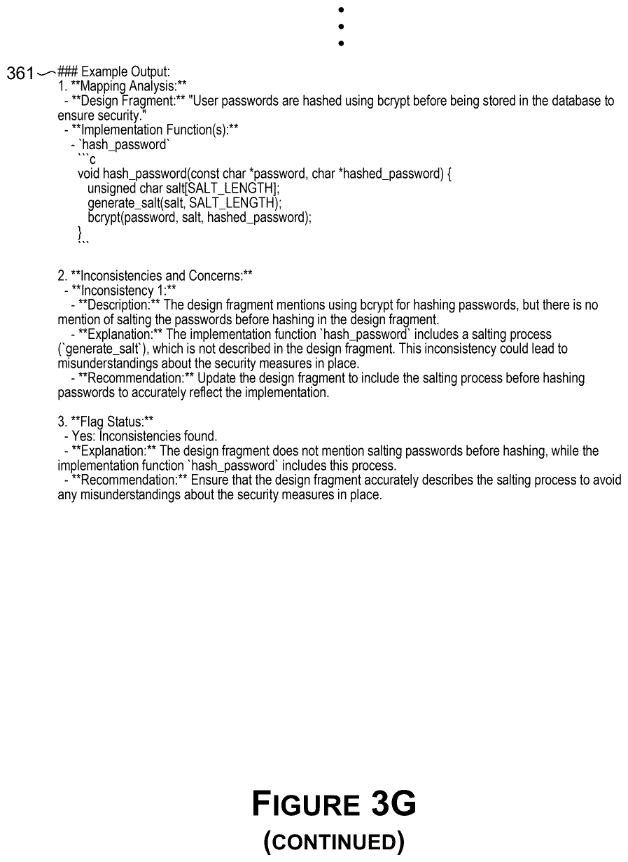

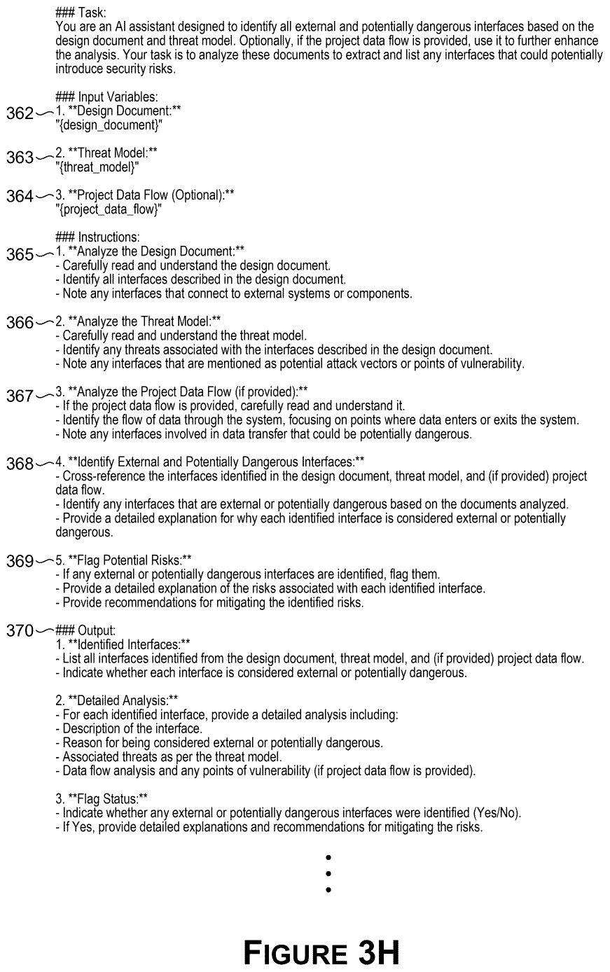

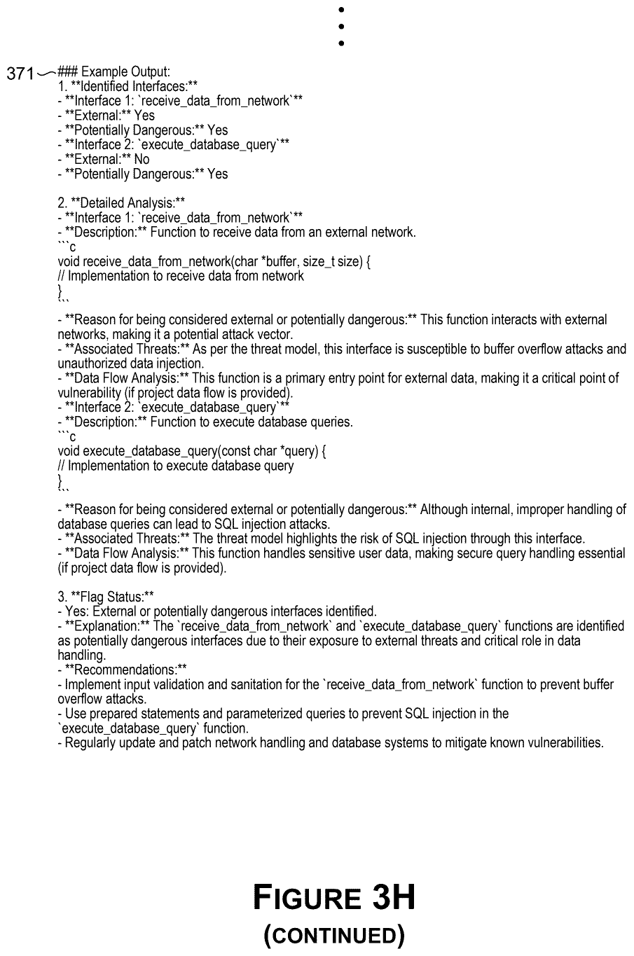

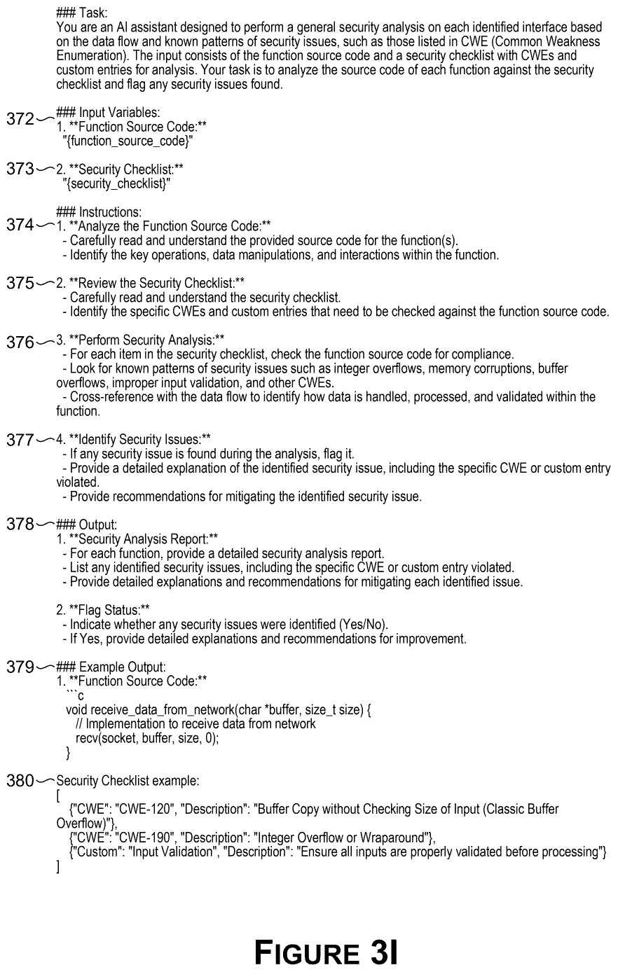

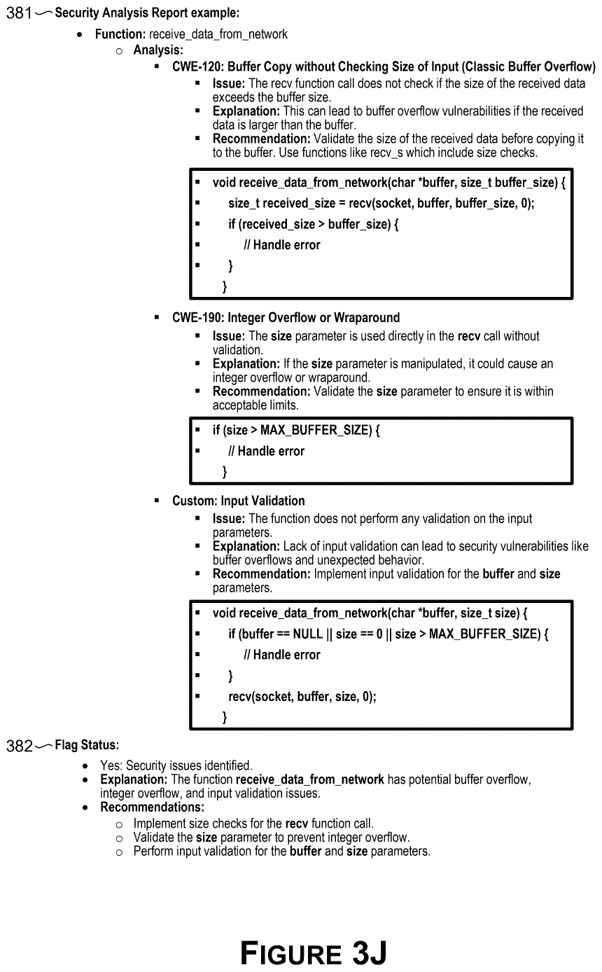

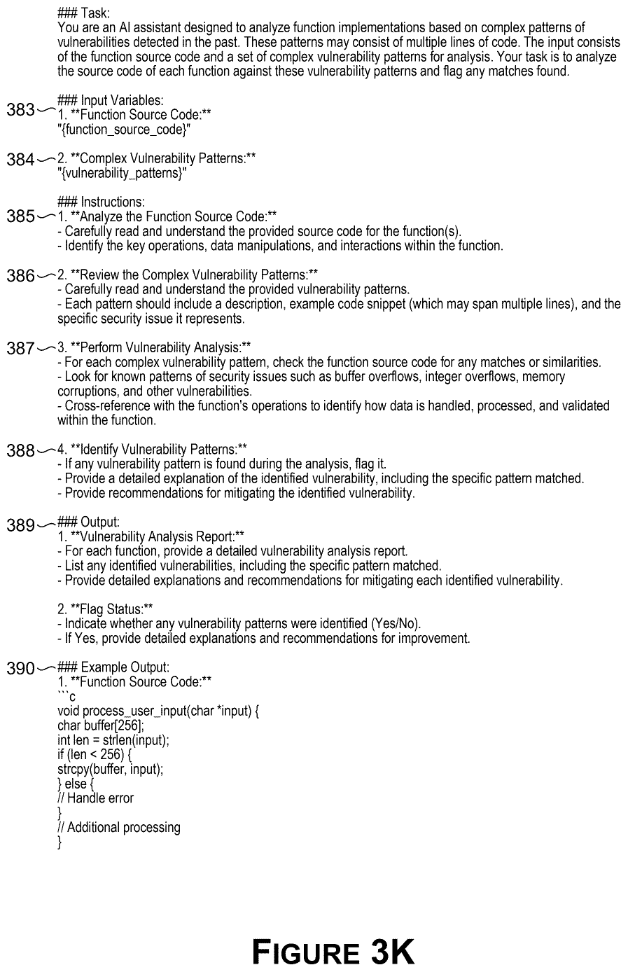

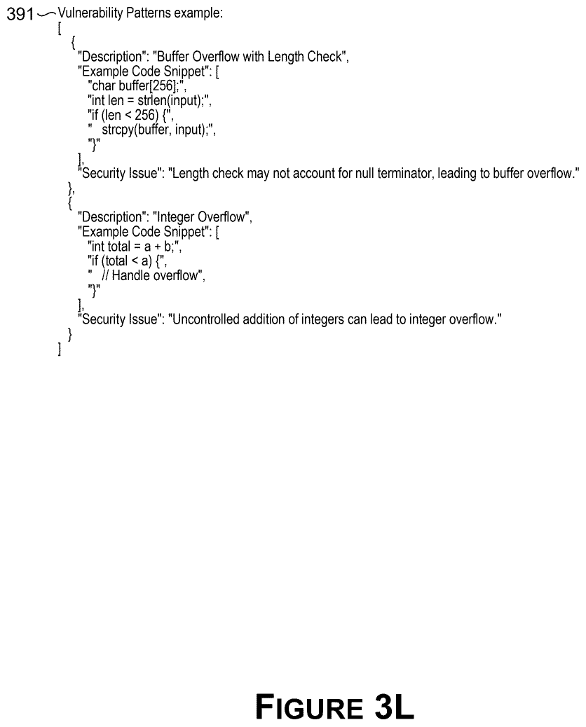

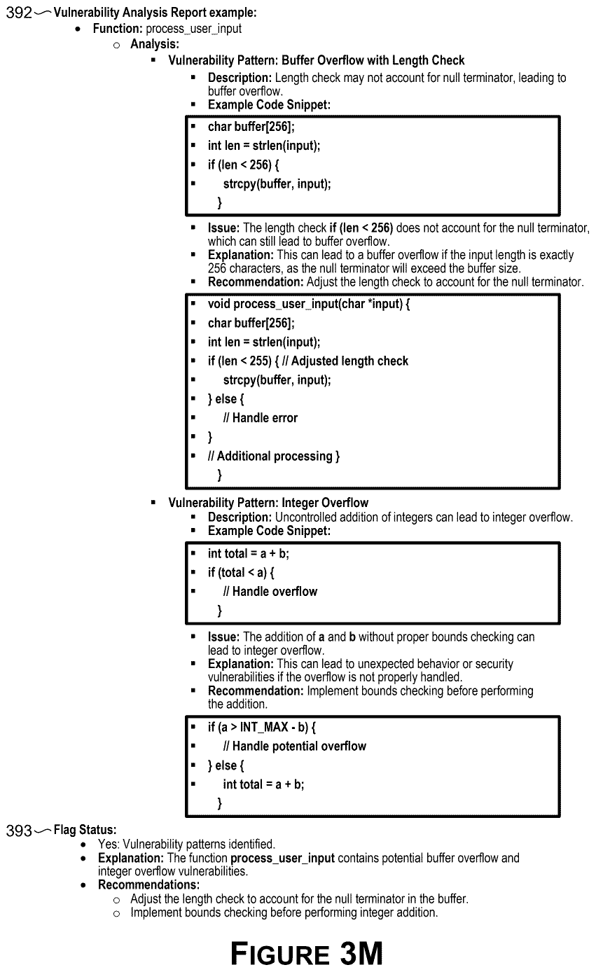

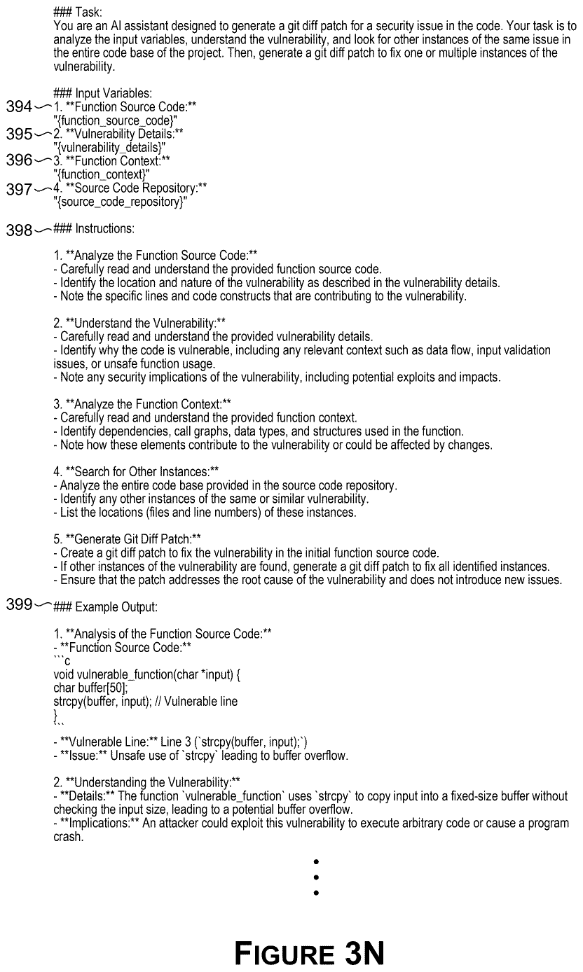

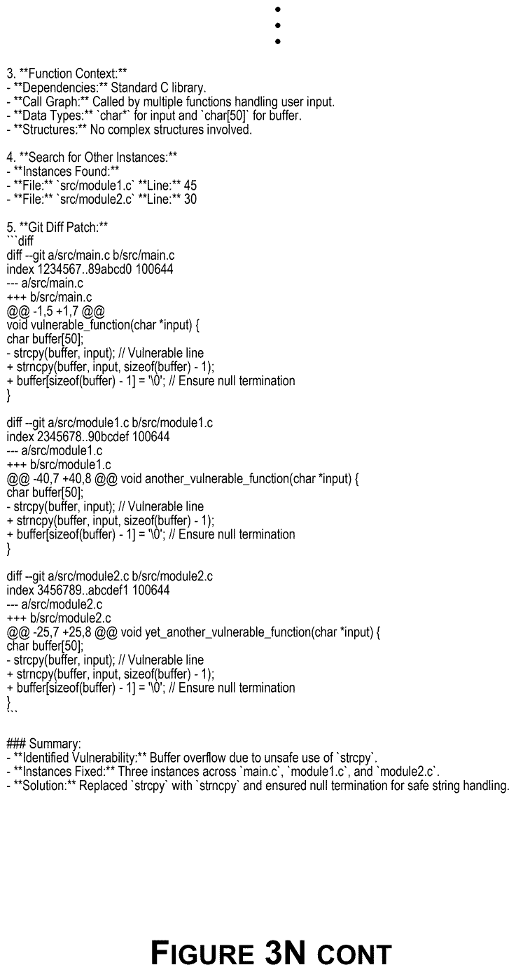

In this way, the design analyzer 230 may generate a design-threat identification prompt that is used to identify design data relevant to a threat(s). In this regard, the design-threat identification prompt may include an instruction to identify design data relevant to or that matches a threat. In some cases, a design-threat identification prompt may be generated for a specific threat. In other cases, a design-threat identification prompt may be generated for a set of threats. A design-threat identification prompt may include a threat(s) as context. In this way, the design-threat identification prompt may be used to search a data store including representations of design data to identify design data relevant to the threat(s). One example prompt is provided in FIG. 3A. In FIG. 3A, input threat 301 is a variable representing a threat. In this way, the input threat may be populated with a threat (e.g., a threat description) during the program execution. The design data (e.g., design documentation) may be retrieved from a database. As shown in FIG. 3A, the prompt includes instructions 302 related to analyzing the input threat, instructions 303 related to identifying a matching design portion, a target output 304, and an example output 305.

In operation, as one example, the design-threat identification prompt, including a threat as context, may be converted into a vector (e.g., embedding), for instance using the LLM or an embedding model, that represents a semantic meaning of the prompt in a high-dimensional space. The generated vector may then be used by the LLM to query a data store that includes precomputed vectors, or embeddings, of the design data. The performed search may result in identifying or retrieving vectors that are most similar to the prompt's vector, for example, based on a similarity metric such as cosine similarity. Such search results may include data entries (e.g., portions of design documents) associated with the closest vectors identified as the most semantically relevant data to the design-threat identification prompt. In this way, design data related to a threat and/or mitigation thereof is automatically identified based on obtained design data.

In accordance with identifying design data relevant to or related to a threat, the design analyzer 230 may facilitate analysis of such identified design data in association with the threat. In some cases, an LLM, or other AI technology, may be used to perform such analysis. In this regard, in cases in which a matching design data fragment is identified, the design data may be analyzed to evaluate if and/or how the product design addresses or mitigates the corresponding security threat(s). In this way, the design analyzer 230 may generate a design-threat analysis prompt that is used to analyze design data relevant to a threat(s). In some cases, a design-threat analysis prompt may be generated for a specific threat. In other cases, a design-threat analysis prompt may be generated for a set of threats. A design-threat analysis prompt may include an instruction to analyze design data in association with a threat, for example, to identify whether the design data mitigates the threat. In some cases, a design-threat analysis prompt may include a threat(s) as context and/or an indication of the relevant design data as context. For example, the design-threat analysis prompt may include the identified relevant design data or include a reference or indication of the relevant design data for use in performing the analysis. As such, the analysis of the design data for analyzing a threat is minimized to the design data previously identified as relevant such that a more efficient analysis is performed.

One example prompt is provided in FIG. 3B. In FIG. 3B, input threat 308 and design document fragment 309 may be variables representing a threat and design data, respectively. In this way, the input threat 308 may be populated with a threat (e.g., a threat description), and the design document fragment 309 may be input with identified design data. As shown in FIG. 3B, the prompt includes instructions 310 related to analyzing the input threat, instructions 311 related to reviewing the design document fragment, instructions 312 related to evaluating the design fragment, instructions 313 related to identified issues, instructions 314 related to flagging the design fragment, a target output 315, and an example output 316.

The design-threat analysis prompt may be provided as input to a LLM to performing analysis of the design data in association with the threat. In particular, the design data may be analyzed to identify whether the design data mitigates the potential security threat. The LLM may provide, as output, security risk data including any data associated with a security risk. Such security risk data may include various types of information. As one example, an indication of whether a particular threat is mitigated may be provided. As another example, an indication of the design data being analyzed may be provided. As yet another example, an extent of likelihood the threat is mitigated may be provided. As yet another example, an extent of the risk of the threat may be provided (e.g., if not properly mitigated). The security risk data may be provided at any level of granularity. For instance, a general indication of a design flaw may be provided. As another example, an explanation of why a design flaw exists may be provided.

Although described as a two-step prompt generation and LLM analysis process (e.g., identifying relevant data and, thereafter, using the relevant data for security analysis), implementations may include any number of steps (e.g., a single prompt generation and analysis step). Further, although various examples perform such a two-step process for each threat (e.g., of a set of obtained threats), such a process may be performed for a set or batch of threats.

The design analyzer 230 may also analyze a design for a product in association with security requirements to identify whether the design has any flaws relative to identified security requirements. To analyze a design(s) in association with security requirement data, the design analyzer 230 may analyze a design(s) in association with various security requirements to identify any potential security risk(s) associated with a product design. A potential security risk may be identified in cases in which a design does not include any indication of achieving or attaining a corresponding security requirement.

As described, security requirement data may include any indication of security requirements or a security checklist for a software product. A design of a software product, as identified via design data, may be analyzed by the design analyzer 230 in accordance with each security requirement to identify whether the security requirement is attained in the design. Such a process may be iterated for various security requirements. Any number of security requirements may be analyzed in association with a product design(s). For example, in some cases, the security requirements to analyze for security issues may be identified as security requirements relevant or related to the product. In other cases, any security requirement obtained may be analyzed for security issues.

The design analyzer 230 may obtain the security requirement data for which to analyze in light of design data in any number of ways and at any time. For example, a list of security requirement may be obtained as input data 280, obtained via the code security data manager 220, accessed via data store 214, and/or the like. Further, the security requirement data may be obtained for analysis by the design analyzer 230 based on expiration of a time duration or an occurrence of an event. For instance, based on a user indicating to perform security analysis, design analysis, and/or design analysis in association with security requirement data, the security requirements may be obtained and analyzed.

In operation, in cases in which the design analyzer 230 obtains a set of security requirement data, the design data may be analyzed in association with each security requirement. To analyze security requirement data in association with a security requirement, the design analyzer 230 may identify relevant design data that corresponds with a security requirement. As described, in one example, design data may be represented via vector data stored in a data store (e.g., a vector store). In this way, for a security requirement, the design analyzer 230 may identify relevant design data based on a search of the corresponding vector data. Stated differently, the design analyzer 230 may identify a fragment in the design documentation that matches or corresponds with a particular security requirement. In accordance with identifying a matching design documentation fragment, the design analyzer 230 may analyze whether the product design addresses the corresponding security requirement. In cases in which the design does not address or attain the corresponding security requirement, the security requirement is identified as a potential security risk. In some implementations, if there is any uncertainty as to whether a design achieves a security requirement, the potential security risk may be logged and identified as a potential security risk. Such a process to identify relevant or matching design data (e.g., via a vector store) in association with a security requirement and, thereafter, analyze such design data may be performed for various security requirements (e.g., each security requirement of a set of security requirements).

In embodiments, AI technology, such as machine learning or other technology, is used to identify and/or analyze relevant portions of a design in association with security requirements. In this way, the design analyzer 230 may include or use AI to identify and/or analyze relevant portions of a design. The design analyzer 230 may include or access any number of AI models or technologies. As one example, a machine learning model in the form of an LLM is used to identify and/or analyze relevant portions of a design in association with security requirements, as described herein.

To use an LLM, the design analyzer 230 may facilitate generating a prompt(s) for inputting into a LLM to identify and/or analyze relevant design data in association with security requirement data. Any number of prompts may be generated to identify and/or analyze relevant design data in association with security requirement data. As one example, a first prompt may be generated and used to identify relevant design data associated with a security requirement(s), and a second prompt may be generated and used to analyze the relevant design data in association with the security requirement(s).

In this way, the design analyzer 230 may generate a design-security requirement identification prompt that is used to identify design data relevant to a security requirement(s). In some cases, a design-security requirement identification prompt may be generated for a specific security requirement. In other cases, a design-security requirement identification prompt may be generated for a set of security requirements. A design-security requirement identification prompt may include an instruction to identify design data relevant to or matching a security requirement(s). In embodiments, a design-security requirement identification prompt may include a security requirement(s) as context. In this way, the design-security requirement identification prompt may be used to search a data store including representations of design data to identify design data relevant to the security requirement(s).

One example prompt is provided in FIG. 3C. In FIG. 3C, input requirement 318 is a variable representing a security requirement. In this way, the input requirement may be populated with a security requirement (e.g., a threat description) during the program execution. The design data (e.g., design documentation) may be retrieved from a database. As shown in FIG. 3C, the prompt includes instructions 319 related to analyzing the input requirement, instructions 320 related to identifying a matching design portion, a target output 321, and an example output 322.

In operation, as one example, the design-security requirement identification prompt, including a security requirement(s) as context, may be converted into a vector (e.g., embedding), for instance using the LLM or an embedding model, that represents a semantic meaning of the prompt in a high-dimensional space. The generated vector may then be used by the LLM to query a data store that includes precomputed vectors, or embeddings, of the design data. The performed search may result in identifying or retrieving vectors that are most similar to the prompt's vector, for example, based on a similarity metric such as cosine similarity. Such search results may include data entries (e.g., portions of design documents) associated with the closest vectors identified as the most semantically relevant data to the design-security requirement prompt. In this way, design data related to a security requirement and/or attainment thereof is automatically identified based on obtained design data.

In accordance with identifying design data relevant to or related to a security requirement, the design analyzer 230 may facilitate analysis of such identified design data in association with the security requirement. In some cases, an LLM, or other AI technology, may be used to perform such analysis. In this regard, in cases in which a matching design data fragment is identified, the design data may be analyzed to evaluate if and/or how the product design addresses the corresponding security requirement(s). In this way, the design analyzer 230 may generate a design-security requirement analysis prompt that is used to analyze design data relevant to a security requirement(s). In some cases, a design-security requirement analysis prompt may be generated for a specific security requirement. In other cases, a design-security requirement analysis prompt may be generated for a set of security requirements. A design-security requirement analysis prompt may include an instruction to analyze design data in light of a security requirement to identify whether the security requirement is addressed in the design data. In embodiments, a design-security requirement analysis prompt may include a security requirement(s) as context and/or an indication of the relevant design data as context. For example, design-security requirement analysis prompt may include the identified relevant design data or include a reference or indication of the relevant design data for use in performing the analysis. As such, the analysis of the product data for analyzing a security requirement is minimized to the design data previously identified as relevant such that a more efficient analysis is performed.

One example prompt is provided in FIG. 3D. In FIG. 3D, input requirement 324 and design document fragment 325 may be variables. In this way, the input requirement and design document fragment may be populated, during the program execution, with security requirement data and design data identified via the prompt provided in FIG. 3C. As shown in FIG. 3D, the prompt includes instructions 326 related to analyzing the input requirement, instructions 327 related to reviewing the design document fragment, instructions 328 related to evaluating the design fragment, instructions 329 related to identifying issues, instructions 330 related to flagging the design fragment, a target output 331, and an example output 332.

The design-security requirement analysis prompt may be provided as input to a LLM to perform analysis of the design data in association with the security requirement. In particular, the design data may be analyzed to identify whether the design data attains the security requirement. The LLM may provide, in response, security risk data indicating or representing any data associated with any security risks. The security risk data may include various types of information. As one example, an indication of whether a particular security requirement is attained may be provided. As another example, an indication of the design data being analyzed may be provided. As yet another example, an extent of likelihood the security requirement is attained may be provided. As yet another example, an extent of the risk of the not attaining a security requirement may be provided (e.g., if not properly addressed). The security risk data may be provided at any level of granularity. For instance, a general indication of a design flaw may be provided. As another example, an explanation of why a design flaw exists may be provided.

By way of example only, assume 28 design flaws are identified as possible security risks associated with a product design being analyzed. In addition to providing an indication of the 28 design flaws, a severity level of not attaining the security requirement may be provided. For example, each design flaw may include an indication of low severity, medium severity, or high severity indicating an extent of security risk that may result by not achieving the corresponding security requirement. In other examples, a numerical score (e.g., between 1 and 10) or any other indicator may be used to visually reflect a severity of a possible security risk. For instance, a Common Vulnerability Scoring System (CVSS) score may be used to reflect a severity. In some embodiments, an LLM may determine or calculate a CVSS score based on the design flaw. Additionally or alternatively, statistics associated with the design flaws may be identified. For instance, a proportion of design flaws found relative to the total number of security requirements analyzed may be identified. As another example, a proportion of high severity design flaws, medium severity design flaws, and low severity design flaws may be identified (e.g., based on CVSS score).

Although described as a two-step prompt generation and LLM analysis process (e.g., identifying relevant data and, thereafter, using the relevant data for security analysis), implementations may include any number of steps (e.g., a single prompt generation and analysis step). Further, although various examples perform such a two-step process for each security requirement (e.g., of a set of obtained security requirement), such a process may be performed for a set or batch of security requirements.

Turning to design analysis in association with PS data and/or OS data, the design analyzer 230 may analyze a design(s) in association with various PS and/or OS data to identify potential security risks associated with a product design. A potential security risk may be identified in cases in which the design data lacks any indication of mitigating a security vulnerability corresponding with PS and/or OS data.

As described, PS data generally refers to information and findings gathered internal to an organization. In this regard, PS data may include examples of security issues found in the code or the design of various projects, which may then be used to improve security across an organization (e.g., a company). OS data generally refers to data collected from open-source projects and, in particular focusing on security issues. Accordingly, open-source data may serve as a library of lessons learned from other projects that can be used to analyze and improve security of an organization's own design or code. PS data and/or OS data may include questions for product design evaluation, vulnerable patterns (e.g., examples of design flaws) based on previous reviews, labeled code snippets indicating flaws, etc.

A design of a software product, as identified via design data, may be analyzed by the design analyzer 230 in accordance with each PS and/or OS pattern to identify whether an occurrence of a same or similar pattern is mitigated in the design. Such a process may be iterated for various PS and/or OS patterns. Any number of PS and/or OS patterns may be analyzed in association with a product design(s). For example, in some cases, the PS and/or OR patterns to analyze for security issues may be identified as PS and/or OS patterns relevant or related to the product. In other cases, any PS and/or OS patterns obtained may be analyzed for security issues. A PS pattern generally refers to an instance or pattern associated with a threat identified in PS data. Similarly, an OS pattern generally refers to an instance or pattern associated with a threat identified in OS data. For example, in some cases, a PS pattern may include data exhibiting a particular threat or security issue identified in PS data.

The design analyzer 230 may obtain PS data and/or OS data for which to analyze in relation to design data in any number of ways and at any time. For example, a list of PS and/or OS patterns may be obtained as input data 280, obtained via the code security data manager 220, accessed via data store 214, and/or the like. Further, PS data and/or OS data may be obtained for analysis by the design analyzer 230 based on expiration of a time duration or an occurrence of an event. For instance, based on a user indicating to perform security analysis, design analysis, and/or design analysis in association with PS data, the PS data may be obtained and analyzed.

In operation, in cases in which the design analyzer 230 obtains a set of PS and/or OS data, the design data may be analyzed in association with each PS pattern and/or OS pattern. To analyze design data in association with a PS pattern and/or OS pattern, the design analyzer 230 may identify relevant design data that corresponds with a PS and/or OS pattern. As described, in one example, design data may be represented via vector data stored in a data store (e.g., vector store). In this way, for a PS pattern and/or OS pattern, the design analyzer 230 may identify relevant design data based on a search of the corresponding vector data. Stated differently, the design analyzer 230 may identify a fragment in the design documentation that matches a particular PS pattern and/or OS pattern. In accordance with identifying a matching design documentation fragment, the design analyzer 230 may analyze whether the product design addresses the corresponding PS pattern and/or OS pattern. In cases in which the design does not address, mitigate, or attain the corresponding PS and/or OS pattern, the PS pattern and/or OS pattern is identified as a potential security risk. In some implementations, if there is any uncertainty as to security risk, the potential security risk may be logged and identified as a potential security risk. Such a process to identify relevant or matching design data (e.g., via a vector store) in association with a PS pattern and/or OS pattern and, thereafter, analyzing such design data may be performed for various PS patterns and/or OS patterns (e.g., each PS pattern of a set of PS patterns).

By way of example, design analysis using PS data and OS data may include examining past issues to ensure they are not repeated in new designs. This process entails comparing portions of a current design to previously identified problematic code or design fragments as indicated in PS patterns and/or OS patterns. For instance, assume PS data includes a design flaw, the relevant code fragment may be isolated and included as a PS pattern (e.g., labeled code snippet indicating an issue and why). An LLM may then compare this fragment indicated in the PS pattern with a design fragment for a product currently being analyzed to identify similar issues. Accordingly, upon identifying relevant portions of a design, the LLM may compare and/or contrast the identified relevant portions to a PS pattern. By incorporating previous findings identified via PS patterns and/or OS patterns, including labeled code snippets and their descriptions, the LLM can translate this knowledge into the analysis of new designs, ensuring that potential security risks identified in past projects are proactively addressed in current ones.

In embodiments, AI technology, such as machine learning or other technology, may be used to identify and/or analyze relevant portions of a design in association with PS patterns and/or OS patterns. In this way, the design analyzer 230 may include or use AI to identify and/or analyze relevant portions of a design. The design analyzer 230 may include or access any number of AI models or technologies. As one example, a machine learning model in the form of an LLM is used to identify and/or analyze relevant portions of a design in association with PS and/or OS patterns, as described herein.

To use a LLM, the design analyzer 230 may facilitate generating a prompt(s) for inputting into a LLM to identify and/or analyze relevant design data in association with PS and/or OS data. Any number of prompts may be generated to identify and/or analyze relevant design data in association with PS and/or OS data. As one example, a first prompt may be generated and used to identify relevant design data associated with a PS and/or OS pattern(s), and a second prompt may be generated and used to analyze the relevant design data in association with the PS and/or OS pattern(s).

In this way, the design analyzer 230 may generate a design-PS identification prompt or a design-OS identification prompt that is used to identify design data relevant to PS data or OS data, respectively. In some cases, a design-PS identification prompt or a design-OS identification prompt may be generated for a specific PS pattern and/or OS pattern. In other cases, a prompt may be generated for a set of PS and/or OS patterns. A design-PS identification prompt may include a PS pattern(s) as context. In this way, the design-PS identification prompt may be used to search a data store including representations of design data to identify design data relevant to the PS pattern(s). Similarly, a design-OS identification prompt may include an OS pattern(s) as context. In this way, the design-OS identification prompt may be used to search a data store including representations of design data to identify design data relevant to the OS pattern(s).

One example prompt is provided in FIG. 3E. In FIG. 3E, input design flaw pattern 334 is a variable representing a design flaw (e.g., identified from a previous review(s) in association with OS data and/or PS data). Design data (e.g., design documentation) may be retrieved from a database. As shown in FIG. 3E, the prompt may include instructions 335 related to analyzing the input design flaw pattern, instructions 336 related to identifying a matching design portion, instructions 337 related to evaluating the design portion, instructions 338 related to identifying issues, instructions 339 related to flagging the design portion, a target output 340, and an example output 341.

In operation, as one example, a design-PS identification prompt, including a PS pattern(s) as context, may be converted into a vector (e.g., embedding), for instance using the LLM or an embedding model, that represents a semantic meaning of the prompt in a high-dimensional space. The generated vector may then be used by the LLM to query a data store that includes precomputed vectors, or embeddings, of the design data. The performed search may result in identifying or retrieving vectors that are most similar to the prompt's vector, for example, based on a similarity metric such as cosine similarity. Such search results may include data entries (e.g., portions of design documents) associated with the closest vectors identified as the most semantically relevant data to the design-PS identification prompt. In this way, design data related to a PS pattern and/or mitigation thereof is automatically identified based on obtained design data.

In accordance with identifying design data relevant to or related to a PS pattern and/or OS pattern, the design analyzer 230 may facilitate analysis of such identified design data in association with the PS pattern and/or OS pattern(s). In some cases, an LLM, or other AI technology, may be used to perform such analysis. In this regard, in cases in which a matching design data fragment is identified, the design data may be analyzed to evaluate if and/or how the product design addresses or mitigates the corresponding PS pattern(s) and/or OS pattern(s). In this way, the design analyzer 230 may generate a design-PS analysis prompt and/or a design-OS analysis prompt that is used to analyze design data relevant to a PS pattern and/or OS pattern, respectively. In some cases, a design-PS analysis prompt and/or design-OS analysis prompt may be generated for a specific PS pattern and/or OS pattern, respectively. In other cases, a design-PS analysis prompt may be generated for a set of PS pattern and/or a design-OS analysis prompt may be generated for a set of OS patterns. A design-PS analysis prompt may include a PS pattern(s) as context and/or an indication of the relevant design data as context. For example, the design-PS analysis prompt may include the identified relevant design data or include a reference or indication of the relevant design data for use in performing the analysis. Similarly, a design-OS analysis prompt may include an OS pattern(s) as context and/or an indication of the relevant design data as context. For example, the design-OS analysis prompt may include the identified relevant design data or include a reference or indication of the relevant design data for use in performing the analysis. As such, the analysis of the product data for analyzing PS data and/or OS data is minimized to the design data previously identified as relevant such that a more efficient analysis is performed.

The design-PS analysis prompt and/or design-OS analysis prompt may be provided as input to an LLM to perform analysis of the design data in association with the PS data and/or OS data, respectively. In particular, the design data may be analyzed to identify whether the design data mitigates or addresses a PS pattern and/or an OS pattern. The LLM may provide, as output, security risk data. Such security risk data may include various types of information. As one example, security risk data provided as output may include an indication of whether a particular PS pattern and/or OS pattern is mitigated. As another example, an indication of the design data being analyzed may be provided. As yet another example, an extent of likelihood the PS and/or OS pattern being mitigated may be provided. As yet another example, an extent of the risk of the not mitigating a PS pattern and/or OS pattern may be provided (e.g., if not properly addressed). The security risk data may be provided at any level of granularity. For instance, a general indication of a design flaw may be provided. As another example, an explanation of why a design flaw exists may be provided.

Although described as a two-step prompt generation and LLM analysis process (e.g., identifying relevant data and, thereafter, using the relevant data to perform security analysis), implementations may include any number of steps (e.g., a single prompt generation and analysis step). Further, although various examples perform such a two-step process for each PS or OS pattern (e.g., of a set of obtained pattern), such a process may be performed for a set or batch of pattern.

In some cases, the design analyzer 230 may perform various analyses sequentially or concurrently. For example, in some cases, the design data may be sequentially analyzed in association with the threat data, the security requirement data, and the PS and/or OS data (in any order). In other cases, the design data may be concurrently analyzed in association with the threat data, the security requirement data, and/or the PS/OS data. Further, depending on the implementation, each analysis type need not be performed. For instance, in cases in which only threat data and security requirement data are obtained, only security analysis of the design relative to the threat data and security requirement data may be performed.

The design-to-code analyzer 240 is generally configured to perform a design-to-code mapping analysis. In this regard, the design-to-code analyzer 240 may map a product design to an actual code implementation to identify whether a developer accurately interprets and reflects the design in the code. At a high level, the design-to-code analyzer 240 performs a design-to-code mapping. In particular, design data (e.g., design documentation) and the corresponding code data (e.g., code repository) are obtained. As one example, for various functions of a set of functions, a search may be performed (e.g., via a query) to identify a corresponding design fragment (e.g., in a data store such as a data store). As such, design data, such as how a door's functionality should work, is mapped with the actual code implementation corresponding therewith. Using a LLM, the codebase and design documents may be examined to find matching elements. The LLM is then prompted to search through the source code stored in a data store to locate the specific code fragment that implements this functionality. The mapped data may then be analyzed to identify any inconsistencies that may be or indicate security issues. In this regard, once these mappings between design and code are established, each mapped pair is further analyzed for inconsistencies. The LLM helps identify any deviations or errors in the code that might have arisen from misinterpretations of the design, ensuring the implementation aligns with the original design intent.

In one embodiment, the design-to-code analyzer 240 may include or use artificial intelligence technology, such as machine learning or other technology, to map data and/or analyze mapped data. As such, the design-to-code analyzer 240 may include or access any number of AI models or technologies. As one example, a machine learning model in the form of an LLM is used to map design to code and/or analyze such mappings. A same or different LLM or AI technology may be used as that described above.

To use a LLM, the design-to-code analyzer 240 may facilitate generating a prompt(s) for inputting into a LLM to map design data to code data associated with a product. Any number of prompts may be generated to map and/or analyze data in association therewith. As one example, a first prompt may be generated and used to map design data to code data, and a second prompt may be generated and used to analyze the mapped data.

In this way, the design-to-code analyzer 240 may generate a design-code mapping prompt that is used to map design data to code data associated with a product. In some cases, a design-code mapping prompt may be generated for a specific design or code data. In other cases, a design-code mapping prompt may be generated for a set of design features or code features. A design-code mapping prompt may include design data and/or code data as context. In this way, the design-code mapping prompt may be used to search a data store including representations of design data to identify design data relevant to a code fragment(s), such as a function.

One example prompt is provided in FIG. 3F. In FIG. 3F, input variables include design fragment 344 and source code repository 345 and, in response, output includes one or more functions implementing the design fragment. As shown in FIG. 3F, the prompt includes instructions 346 related to analyzing design fragment, instructions 347 related to identifying matching implementations in source code, instructions 348 related to evaluating the implementations, instructions 349 related to creating design-implementation mappings, instructions 350 related to flag status, a target output 351, and an example output 352.

In operation, as one example, the design-code mapping prompt, including a code function(s) as context, may be converted into a vector (e.g., embedding), for instance using the LLM or an embedding model, that represents a semantic meaning of the prompt in a high-dimensional space. The generated vector may then be used by the LLM to query a data store that includes precomputed vectors, or embeddings, of the design data. The performed search may result in identifying or retrieving vectors that are most similar to the prompt's vector, for example, based on a similarity metric such as cosine similarity. Such search results may include data entries (e.g., portions of design documents) associated with the closest vectors identified as the most semantically relevant data to the design-code mapping prompt. In this way, design data related to a code fragment, such as a code function, is automatically identified. Accordingly, to match design to implementation, for each function, a query or prompt is used to identify a corresponding design data fragment.

In cases in which no match or relevant design data is identified for a code fragment, such as a code function, a non-match may be identified and recorded. In this way, the non-match recordation signifies the code fragment may not match the design for the product.

In accordance with identifying design data relevant to or related to a code fragment (e.g., a code function), the code-to-design analyzer 230 may generate a mapping table that includes the various design-code mappings. For example, a mapping may be generated that maps code functions to corresponding design fragments. With reference to FIG. 3F, an example of an identified entry for a mappings dictionary 353 is provided. Such a mapping(s) may be stored, for example, via data store 212. Storing the mapping facilitates subsequent utilization of the mappings (e.g., via the code analyzer 240).

For a code-to design match (e.g., as indicated in a mapping table), the code-to-design analyzer 230 may facilitate analysis of such identified design data in association code fragment. In this regard, the code-to-design analyzer 230 may identify any inconsistencies between the matched code data and design data. An inconsistency indicates that the code and design do not align, thereby indicating that the code implementation is not as designed. Any such inconsistencies may be identified and provided as output data.

In some cases, an LLM, or other AI technology, may be used to perform such analysis. In this regard, in cases in which a matching design data fragment is identified in association with a code fragment (e.g., a code function), the data may be analyzed to evaluate any inconsistencies between the data. In this way, the design-to-code analyzer 240 may generate a design-code analysis prompt that is used to analyze similarities and/or differences between the design data and matching code portion. In some cases, a design-code analysis prompt may be generated for a specific design-code match. In other cases, a design-code analysis prompt may be generated for a set of design-code matches. A design-code analysis prompt may include a design data and/or code data as context and/or an indication of such data. For example, the design-code analysis prompt may include the identified design-code match or include a reference or indication of the design-code match for use in performing the analysis. As such, the analysis of the design and/or code data is minimized to the design-code match previously identified such that a more efficient analysis is performed.

As can be appreciated, in other cases, a design-to-code analyzer 240 may additionally or alternatively identify code fragments (e.g., functions) that map to or match a design feature. For example, for a particular design feature, the source code represented in the data store may be searched to identify a code fragment of the functionality that implements the particular design feature.

One example prompt is provided in FIG. 3G. In FIG. 3G, an input variable includes a design-to-implementation mapping(s) 354. As shown in FIG. 3G, the prompt includes instructions 355 related to iterating through each mapping, instructions 356 related to analyzing the design fragment, instructions 357 related to analyzing corresponding implementation(s), instructions 358 related to comparing design and implementation(s), instructions 359 related to flag inconsistencies, a target output 360, and an example output 361.

The design-code analysis prompt may be provided as input to a LLM to performing analysis of the design data in association with the code data. In particular, the design data and corresponding or matching code data may be analyzed to identify whether any inconsistencies or code gaps relative to the design (design versus code gaps indicating code is not working as it should relative to the design—or missing code) exist between the matching data. The security results or output may include various types of information. As one example, an indication of whether an inconsistency exists may be provided. As another example, an indication of the design data and/or code data being analyzed may be provided. As yet another example, an extent of likelihood of an inconsistency may be provided. As yet another example, an extent of the risk of the not identifying an inconsistency may be provided (e.g., if not properly addressed). The security results may be provided at any level of granularity. For instance, a general indication of a design-to-code inconsistency may be provided. As another example, an explanation of why a design-to-code inconsistency exists may be provided. Such security results may be stored and/or provided for subsequent use.

Although described as a two-step prompt generation and LLM analysis process (e.g., identifying relevant data and, thereafter, using the relevant data), implementations may include any number of steps (e.g., a single prompt generation and analysis step). Further, although various examples perform such a two-step process for each design-code pair (e.g., of a set of obtained design-code pairs), such a process may be performed for a set or batch of design-code matches.

The code analyzer 250 is generally configured to analyze code associated with a product, or a portion thereof, to identify security risk associated therewith. In this way, the code may be analyzed for security risks, even in instances in which a design is suitable for a product and implemented in accordance with such a suitable design. In embodiments, the code analyzer 250 may analyze code to identify security risks that may exist in accordance with the programming language or implementation used to create the software product. For instance, dangerous patterns (e.g., direct access to memory) may result from code generation based on the coding or programming language. By way of example only, assume a particular programming language includes direct access to memory. In such a case, a developer may inadvertently introduce a security issue in association with the code developed. As such, the code analyzer 250 may analyze code and programming language specific aspects to identify any security risks.

In embodiments, the code analyzer 250 may perform data flow analysis, code analysis using PS data and/or OS data, and/or test coverage analysis to facilitate code analysis to identify security risk data. Data flow analysis generally refers to analyzing the flow of data in association with code to identify a security risk(s). In particular, for data flow analysis, the code analyzer 250 analyzes inputs to source code functions and how such inputs are subsequently used in the functional logic. In this way, the code analyzer 250 may identify the data flow and interfaces exposed to users to identify potential security issues. By way of example only, assume ten Bytes of memory are intended to be read. However, further assume a user may input to read 100 Bytes of memory. In such a case, the code may read more data than intended, which may result in a potential security risk.

To perform data flow analysis, initially, code may be analyzed to identify particular code fragments to further analyze for security issues. In this way, code corresponding with potential user access or interfaces may be further analyzed. In some cases, to identify code fragments, a set of code functions may be analyzed. As one example, a set of design-code mappings may be analyzed to identify code functions that include interfaces exposed to a user. In this regard, the code analyzer 250 may access the design-code mappings (e.g., generated via design-to-code analyzer 240) to identify functions that may correspond with data input and/or output that expose data to a user, and, as such, may introduce security risks and should be further evaluated. In some embodiments, design data and/or threat data may be used to facilitate identification of data flow and interfaces exposed to a user. For example, design data and/or threat data may indicate or include user interface exposures. Identifying functions that may expose interfaces or data to users is valuable to perform an efficient data flow analysis. For instance, various code functions may not include any interfaces or user exposures and, as such, do not need to be further evaluated for potential security risks.

In some cases, the code analyzer 250 uses AI technology to facilitate identification of code functions to further evaluate. For example, the code analyzer 250 may facilitate generation of a code interface prompt to identify code fragments, such as functions, that may expose a security risk (e.g., interfaces). By way of example only, the code analyzer 250 may access a code function (e.g., via a design-code mapping) and generate a prompt to analyze the code function to identify the data input to the function, how it is used by the function, and/or the data output by the function. One example prompt is provided in FIG. 3H. In FIG. 3H, input variables may include a design document 362, a threat model 363, and a project data flow 364. As shown in FIG. 3H, the prompt includes instructions 365 related to analyzing the design document, instructions 366 related to analyzing the threat model, instructions 367 related to analyzing the project data flow, instructions 368 related to identifying interfaces, instructions 369 related to flagging potential risks, a target output 370, and an example output 371.

The code interface prompt may be input to an LLM to identify interfaces or data exposed to a user and, in response, the LLM may provide an output indicating such requested information. For instance, an LLM response may include security risk data that indicates inputs into a function, a type(s) of operation(s) used in association with the inputs, and/or an indication of whether the data is trusted or untrusted data. In some cases, such prompts may be specific to a particular code function. In other cases, a prompt may include various code functions.

In accordance with identifying a function to further analyze (e.g., based on a potential interface or data exposure to user or other security issue), the code analyzer 250 may analyze the function for a potential security issue. By way of example only, assume an implementation of a function uses untrusted data to perform a particular operation, such as memory access. In such a case, the data flow associated with the function may be identified as having a dangerous pattern and, therefore, be a potential security issue.

In embodiments, the code analyzer 250 may use AI technology, such as an LLM, to facilitate identification of security risks. For example, an LLM may be used to analyze whether a data flow associated with a function corresponds with or matches a security risk pattern identified as a potential security issue. In this regard, one or more code analysis prompts may be generated to identify whether the data flow associated with a function matches a security risk pattern. A security risk pattern may include any known pattern that indicates a security vulnerability. In embodiments, such security risk patterns may correspond to the particular programming code used to create or develop the product. One example of a security risk pattern may reflect a memory corruption(s). A memory corruption generally refer to instances where a program unintentionally modifies memory (e.g., buffer overflows, use-after-free, heap corruption, etc.). Another example of a security risk pattern is an integer overflow. An integer overflow may occur when an arithmetic operation results in a value exceeding the maximum (or minimum) value the data type can hold, which may result in an unexpected value. Other examples of security vulnerabilities that may arise due to characteristics and/or features of programming languages may include SQL injection, cross-site scripting, cross-site request forgery, command injection, path traversal, buffer overflow, use-after-free, null pointer dereference, deserialization vulnerabilities, etc. Such security risk patterns may be analyzed individually or as a set. For instance, as one example, analysis of a memory operation may be analyzed (e.g., to identify whether a potential memory corruption exists) to identify if the data flow resulting from the first prompt can be used in any memory-related operations and, thereafter, an integer overflow analysis may be performed.

One example prompt is provided in FIG. 3I. In FIG. 3I, input variables may include a function source code 372 and a security checklist 373. As shown in FIG. 3I, the prompt includes instructions 374 related to analyzing the function source code, instructions 375 related to reviewing the security checklist, instructions 376 related to performing security analysis, instructions 377 related to identifying security issues, a target output 378, and an example output 379. An example security checklist 380 is also illustrated in FIG. 3I.

In response to a code analysis prompt input to an LLM, the LLM may provide, as output, security risk data representing a possible security risk(s) associated with product code. Such security risk data may include any type of information related to a security risk and be provided in any number for forms. In one example, output security risk data may indicate whether a function exposing an interface to a user is related to a security risk pattern. In another example, security risk data may indicate a code fragment where the data coming into a function is used in a memory copy operation. FIG. 3J provides an example of a security analysis report 381 and a flag status 382.

As described, the code analyzer 250 may also perform code analysis using PS data and/or OS data. In this case, code may be analyzed to identify or determine whether the code contains a specific security risk pattern(s) identified via PS data and/or OS data. In such a case, a code function may be compared to a security risk pattern generated via PS data and OS data. The security risk pattern may be a generic pattern generated or extracted based on PS data or OS data. In other cases, a security risk pattern may be an example of data (e.g., code) that contains a security risk. In embodiments, AI technology, such as an LLM, may be used to determine whether a code function(s) exhibits or matches a security risk pattern(s). In this way, similarities between a code function and a security risk pattern may be identified via a prompt input to an LLM. In cases in which similarities, or an extent of similarities are identified, the security risk pattern may be identified as a match. The particular security risk patterns generated from PS data and/or OS data that are analyzed may be predetermined, dynamically determined (e.g., based on the code or product associated therewith, etc.), or the like.

One example prompt is provided in FIG. 3K. In FIG. 3K, input variables may include a function source code 383 and a vulnerability pattern 384. As shown in FIG. 3I, the prompt includes instructions 385 related to analyzing the function source code, instructions 386 related to reviewing vulnerability patterns, instructions 387 related to performing vulnerability analysis, instructions 388 related to identifying vulnerability patterns, a target output 389, and an example output 390. An example vulnerability pattern 391 is provided in FIG. 3L.

In response to a code analysis prompt input to an LLM, the LLM may provide, as output, security risk data representing a possible security risk(s) associated with product code based on a security risk pattern generated via PS data and/or OS data. Such security risk data may include any type of information related to a security risk and be provided in any number for forms. In one example, output security risk data may indicate whether a security risk pattern matching or similar to a code or code function. In another example, security risk data may indicate similarities between a code, or portion thereof, and a corresponding security risk pattern generated via PS data and/or OS data. One example of a vulnerability analysis report 392 and a flag status 393 is provided in FIG. 3M.

The code analyzer 250 may alternatively or additionally perform test coverage analysis to facilitate code analysis. In this regard, the code analyzer 250 may identify whether any security test(s) covers or corresponds with a code fragment (e.g., function). A security test generally refers to any test used to recognize or verify a security risk. Examples of security tests include unit tests, integration tests, fuzzing test, and/or the like. Unit tests are generally a more granular level of testing focusing on individual units of code (e.g., functions or methods) to ensure such units of code perform as expected in isolation. Unit tests may be used to verify that the units of code (e.g., functions) operate correctly on their own. Integration tests evaluate the interactions between multiple units of code to ensure they work together correctly. Integration tests may verify that different modules or services integrate properly and ensure that components, when combined, produce a desired outcomes. Fuzzing tests generally provide random, unexpected, or invalid inputs to the software to discover security vulnerabilities, crashes, and/or unexpected behaviors. Fuzzing tests may identify edge cases and potential security vulnerabilities that standard testing might miss and ensure software appropriate handles unexpected or malformed inputs. By covering functions with these different types of tests, developers can ensure the software is robust, reliable, and secure. As such, performing test coverage analysis provides valuable insight into potential security risks associated with code, or a portion thereof.

In some cases, the code analyzer 250 may identify whether any security tests cover a code fragment based on an identification of a security risk associated with the code fragment. For example, assume a security risk is identified in association with a particular code function data flow analysis or analysis of PS and/or OS data. In such a case, the code analyzer 250 may identify whether a security test exists for the code function. An indication of such information may be provided, for example, for display to a user, which may be valuable information related to the security of the code. For example, in cases in which a security test is not identified in association with the code function, a user may understand why the security issue exists. On the other hand, in cases in which a security test is identified in association with the code function, a user may identify or evaluate why the security test did not recognize the security issue.

The code analyzer 250 may identify and/or capture data or statistics associated with various code-related analysis. For example, a code analyzer 250 may detect or identify a number of security risks identified in association with data flow analysis and/or analysis of PS and/or OS data, a number of functions associated with security risks, a number of functions covered by unit tests, a number of functions covered by integration tests, a number of functions covered by fuzzing test, etc.

The various components security analysis manager 212 may operate in various manners. In some cases, the security analysis manager 212 may perform various analyses sequentially or concurrently. For example, in some cases, the design analysis, design-to-code analysis, and code analysis may be sequentially performed (e.g., in a predetermined order). In other cases, the design analysis, design-to-code analysis, and/or the code analysis may be concurrently performed in association with a product. Further, depending on the implementation, each type of analysis need not be performed. For instance, the particular type(s) of analysis performed in association with a product may depend on the type(s) of data obtained or available to the security analysis manager 212.

The results provider 260 is generally configured to provide analysis results, such as security risk data 292 of output data 290 identified by performing design analysis, design-to-code analysis, and/or code analysis. In this way, any indication of a security risk, or data associated therewith, may be provided. In some cases, security risk data is provided for display to a user, such as a user requesting to perform a security analysis and/or view such data. In this way, security risk data may be provided, via a network, to a user device for display to a user. Alternatively or additionally, security risk data may be provided to another component or resource for storage and/or further analysis or utilization. As one example, upon identifying a security risk, data associated therewith may be provided to another component that facilitates modification of the code to overcome or repair the security risk.

As described, security risk data may include any representation or indication of a security risk. Various examples of security risk data include an indication of code location (e.g., line) corresponding with a possible security risk, a code fragment associated with the security risk, a risk score associated with a possible security risk indicating a likelihood of the risk and/or a severity of the security risk, an explanation or reason related to severity of the security risk or likelihood of the security risk, analysis performed to identify a possible security risk, source used to identify potential security risk (e.g., threat data, security requirement, etc.), and/or the like.

The solution manager 270 is generally configured to manage solutions in association with security risks. In this regard, the solution manager 270 may manage solutions for security risks identified by performing design analysis, design-to-code analysis, and/or code analysis. In embodiments, the solution manager 270 may facilitate generation of a solution for a security risk(s). To this end, for a security risk associated with code, the solution manager 270 may facilitate generation of a code solution, and for a security risk associated with a design, the solution manager 270 may facilitate generation of a design solution. In this way, security risks solutions may be automatically generated to reduce or fix possible security risks.

In some embodiments, AI may be used to facilitate automatic generation of security risk solutions. As one example, an LLM may be used to obtain a prompt and, in response, provide a security risk solution that address or mitigates the security risk. For example, based on a security risk detected in code and context associated therewith (e.g., identification of the security risk, location of risk, function relationships, etc.), an LLM may be used to generate a fix or patch for the portion of the code containing the security risk. In this way, a solution identification prompt may be generated for input to the LLM. Such a solution identification prompt may include a security risk (e.g., as detected or identified by the security analysis manager 212), code or design data, or relevant portion associated with the security risk (e.g., code including the security risk and other functions related to such code), code relationships (e.g., dependencies and relationships between functions), etc. Code relationships may assist an LLM to understand the sequence of calling functions and better understand the code, thereby facilitating identification of a more suitable solution. One example for providing code relationships may include providing a call graph that indicates the sequence of functions (e.g., function A calls function B, etc.). A call graph may model interprocedural control flow in a manner that visually represents the flow between methods. In some cases, a previously generated call graph may be obtained from a data store. In other cases, a call graph may be generated in association with the code.

One example prompt is provided in FIG. 3N. In FIG. 3N, input variables may include a function source code 394, a set of vulnerability details 395 (e.g., security risks), function context 396 (e.g., call graph, dependencies, and/or data types used in the function), and a source code repository 397. As shown in FIG. 3N, the prompt includes various instructions 398 related to analyzing the function source code, understanding the vulnerability, analyzing the function context, searching for other instances, and generating a patch. An example output 399 is also provided, as shown in FIG. 3N.

In some cases, a security risk solution(s) identified may be automatically used to test the code and/or the design. For example, assume a code solution is produced or generated by the LLM. In such a case, the code solution can automatically replace the code portion(s) with the security risk. As such, the solution manager 270 may replace the portion associated with a security risk with the generated solution and initiate a test. For instance, assume a code patch is generated for a security risk identified in a code. The impacted code with the identified security risk may be replaced with the code patch and, thereafter, the code with the code patch may be executed and/or analyzed (e.g., via security analysis manager 212) to identify whether the security risk is mitigated.

In embodiments, identified security risk solutions 294 may be provided as output data 290. In some cases, identified solutions may be automatically implemented. For example, in accordance with identifying and testing a security risk solution, the solution may be automatically integrated with the code and/or design. In other cases, an identified solution may be recommended or provided to a user for review. For example, an engineer or security analyzer may review the security risk solution and select whether to integrate the security risk solution (e.g., by accepting or rejecting implementation via a user interface).

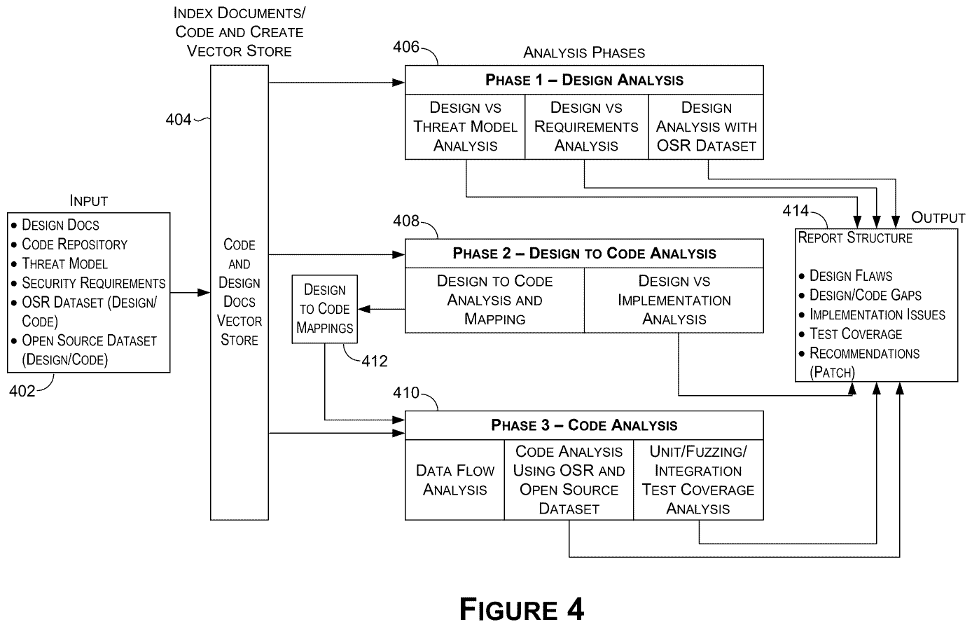

Turning to FIG. 4, FIG. 4 provides example flow for facilitating management of automated security analysis, in accordance with embodiments described herein. As shown in FIG. 4, various types of data may be provided as input 402 to data store 404 (e.g., a vector data store). Examples of such data include design documents, a code repository, a threat model, a security requirement(s), PS dataset, OS dataset, etc. The data stored in data store 404 may be accessed and used to perform various analysis phases. For example, various data may be used to perform design analysis 406. As described, design analysis may include analyzing a design in relation to threat data, security requirement data, and/or PS/OS data. Various data may additionally or alternatively be used to perform design-to-code analysis 408. Design-to-code analysis may include performing design-to-code analysis and generating design-to-code mappings 412 as well as design-to-implementation analysis. Further, various data may additionally or alternatively be used to perform code analysis 410, which may include data flow analysis, code analysis using PS and/or OS data, and/or test coverage analysis. Any of such analyses (e.g., design analysis, design-to-code analysis, and/or code analysis) may be used to generate output 414 including various security risks identified via the different analyses.

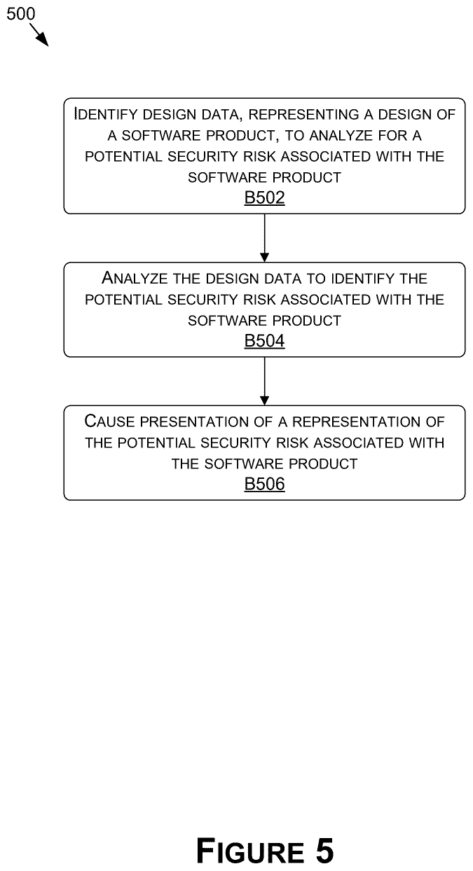

Now referring to FIGS. 5-7, each block of methods 500, 600, and 700 described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, methods 500, 600, and 700 are described, by way of example, with respect to the system of FIG. 1 and FIG. 2. However, this method may additionally or alternatively be executed by any one system, or any combination of systems, including, but not limited to, those described herein.

FIG. 5 is a flow diagram showing a method 500 for performing automated security analysis, in accordance with some embodiments of the present disclosure. The method 500, at block B502, includes identifying, via one or more machine learning models, design data, representing a design of a software product, to analyze for a potential security risk associated with the software product. In some cases, design data to analyze is identified by inputting a prompt into a large language model of the one or more machine learning models to identify the design data relevant to a security threat and obtaining, in response to the prompt, a representation of the design data relevant to the security threat. Additionally or alternatively, design data to analyze is identified by inputting a prompt into a large language model of the one or more machine learning models to identify the design data relevant to a security requirement and obtaining, in response to the prompt, a representation of the design data relevant to the security requirement. Further, in some cases, the design data to analyze may be identified by inputting a prompt into a large language model of the one or more machine learning models to identify the design data relevant to a proprietary security pattern or an open-source pattern and obtaining, in response to the prompt, a representation of the design data relevant to the proprietary security pattern or the open-source pattern. In yet other cases, the design data to analyze may be identified by inputting a prompt into a large language model of the one or more machine learning models to identify the design data relevant to a code fragment and obtaining, in response to the prompt, a representation of the design data relevant to the code fragment.

The method 500, at block B504, includes analyzing (e.g., using one or more machine learning models) the design data to identify the potential security risk associated with the software product. In some cases, analyzing the design data to identify the potential security risk associated with the software product includes determining, using a large language model of the one or more machine learning models, that the design data fails to mitigate a security threat, fails to attain a security requirement, and/or fails to address a PS pattern or OS pattern. In other cases, analyzing the design data to identify the potential security risk associated with the software product comprises determining, using a large language model of the one or more machine learning models, an inconsistency between the design data and a code fragment identified as relevant to the design data.

The method 500, at block B506, includes causing presentation of a representation of the potential security risk associated with the software product. The representation of the potential security risk may be presented in any number of ways via a user interface. For example, the representation of the potential security risk may be presented in a report format or an alert format.

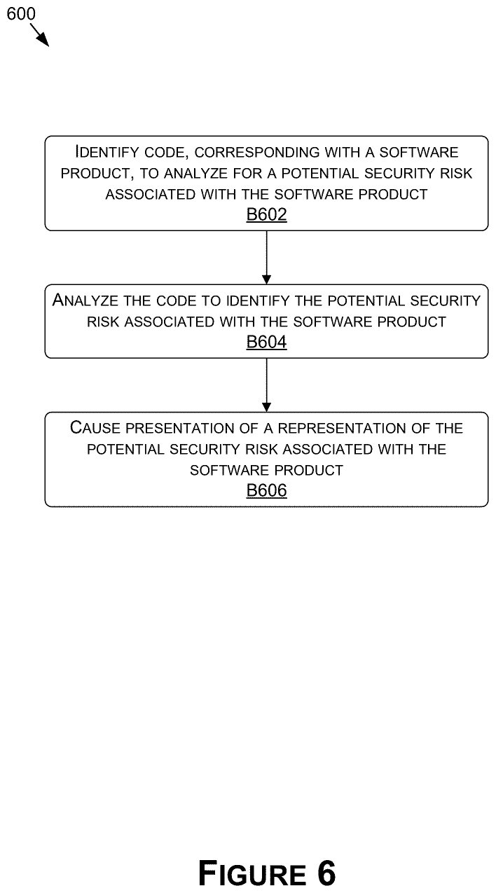

FIG. 6 provides a flow diagram showing a method 600 for performing automated security analysis, in accordance with some embodiments of the present disclosure. The method 600, at block B602, includes identifying, using one or more machine learning models, code, corresponding with a software product, to analyze for a potential security risk associated with the software product. In embodiments, the code includes a code function corresponding with a potential exposed interface. In some cases, the code to analyze is identified by inputting a prompt into a large language model of the one or more machine learning models to identify the code corresponding with a potential exposed interface and obtaining, in response to the prompt, a representation of the code corresponding with the potential exposed interface.

The method 600, at block B604, includes analyzing, using the one or more machine learning models, the code to identify the potential security risk associated with the software product. In some cases, analyzing the code to identify the potential security risk associated with the software product includes determining, using a large language model of the one or more machine learning models, that a data flow associated with the code corresponds with a representation of a security risk pattern or that the code includes a security risk pattern generated based on proprietary security data or open-source data.

The method 600, at block B606, includes causing presentation of a representation of the potential security risk associated with the software product. Such a presentation may be in any number of formats and is not intended to be limited herein. In some cases, in association with identifying a potential security risk, a security risk solution may be identified or generated (e.g., via one or more ML models) for the potential security risk.

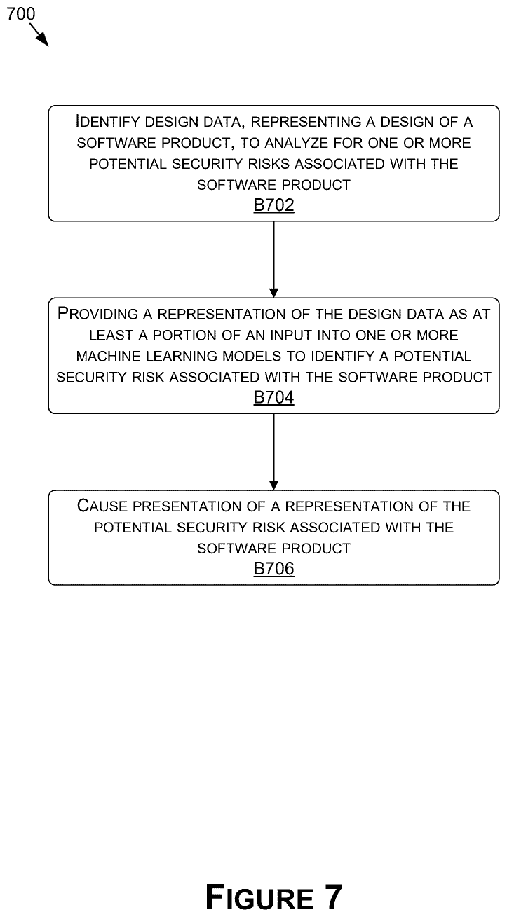

Turning to FIG. 7, FIG. 7 provides a flow diagram showing a method 700 for performing automated security analysis, in accordance with some embodiments of the present disclosure. The method 700, at block B702, includes identifying design data, representing a design of a software product, to analyze for one or more potential security risks associated with the software product.

The method 700, at block B704, includes providing a representation of the design data as at least a portion of an input into one or more machine learning models to identify a potential security risk associated with the software product. In some cases, the input includes a prompt and the one or more machine learning models includes a large language model. A prompt may include various other data, such as a representation of threat data, security requirement data, proprietary security data, or open-source data for use in identifying the potential security risk associated with the software product. As another example, the prompt may include a representation of code corresponding with the design data for use in identifying the potential security risk associated with the software product.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type - including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1061(1)-1016(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
identify, using one or more machine learning models, design data, representing a design of a software product, to analyze for a potential security risk associated with the software product;
analyze, using the one or more machine learning models, the design data to identify the potential security risk associated with the software product; and
cause presentation, using at least one of a display device or a sound device, of a representation of the potential security risk associated with the software product.

2. The one or more processors of claim 1, wherein the design data to analyze is identified by inputting a prompt into a large language model of the one or more machine learning models to identify the design data relevant to a security threat, and obtaining, in response to the prompt, a representation of the design data relevant to the security threat.

3. The one or more processors of claim 1, wherein the design data to analyze is identified by inputting a prompt into a large language model of the one or more machine learning models to identify the design data relevant to a security requirement, and obtaining, in response to the prompt, a representation of the design data relevant to the security requirement.

4. The one or more processors of claim 1, wherein the design data to analyze is identified by inputting a prompt into a large language model of the one or more machine learning models to identify the design data relevant to a proprietary security pattern or an open-source pattern, and obtaining, in response to the prompt, a representation of the design data relevant to the proprietary security pattern or the open-source pattern.

5. The one or more processors of claim 1, wherein analyzing the design data to identify the potential security risk associated with the software product comprises determining, using a large language model of the one or more machine learning models, that the design data fails to mitigate a security threat.

6. The one or more processors of claim 1, wherein analyzing the design data to identify the potential security risk associated with the software product comprises determining, using a large language model of the one or more machine learning models, that the design data fails to attain a security requirement.

7. The one or more processors of claim 1, wherein analyzing the design data to identify the potential security risk associated with the software product comprises determining, using a large language model of the one or more machine learning models, that the design data fails to address a proprietary security pattern or an open-source pattern.

8. The one or more processors of claim 1, wherein the design data to analyze is identified by inputting a prompt into a large language model of the one or more machine learning models to identify the design data relevant to a code fragment, and obtaining, in response to the prompt, a representation of the design data relevant to the code fragment.

9. The one or more processors of claim 1, wherein analyzing the design data to identify the potential security risk associated with the software product comprises determining, using a large language model of the one or more machine learning models, an inconsistency between the design data and a code fragment identified as relevant to the design data.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

11. A system comprising one or more processors to:
identify, using one or more machine learning models, code, corresponding with a software product, to analyze for a potential security risk associated with the software product;
analyze, using the one or more machine learning models, the code to identify the potential security risk associated with the software product; and
cause presentation, using at least one of a display device or a sound device, of a representation of the potential security risk associated with the software product.

12. The system of claim 11, wherein the code comprises a code function corresponding with a potential exposed interface.

13. The system of claim 11, wherein the code to analyze is identified by inputting a prompt into a large language model of the one or more machine learning models to identify the code corresponding with a potential exposed interface, and obtaining, in response to the prompt, a representation of the code corresponding with the potential exposed interface.

14. The system of claim 11, wherein analyzing the code to identify the potential security risk associated with the software product comprises determining, using a large language model of the one or more machine learning models, that a data flow associated with the code corresponds with a representation of a security risk pattern or that the code includes a security risk pattern generated based on proprietary security data or open-source data.

15. The system of claim 11 further comprising generating, using the one or more machine learning models, a security risk solution for the potential security risk associated with the software product.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or a system implemented at least partially using cloud computing resources.

17. A method comprising:
identifying design data, representing a design of a software product, to analyze for one or more potential security risks associated with the software product;
providing a representation of the design data as at least a portion of an input into one or more machine learning models to identify a potential security risk associated with the software product; and
causing presentation, using at least one of a display device or a sound device, of a representation of the potential security risk associated with the software product.

18. The method of claim 17, wherein the input includes a prompt and the one or more machine learning models includes a large language model, and wherein the prompt further includes a representation of threat data, security requirement data, proprietary security data, or open-source data for use in identifying the potential security risk associated with the software product.

19. The method of claim 17 wherein the input includes a prompt and the one or more machine learning models includes a large language model, and wherein the prompt further includes a representation of code corresponding with the design data for use in identifying the potential security risk associated with the software product.

20. The method of claim 17, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
